(19) United States
(12) Patent Application Publication
(10) Pub. No.: US 2010/0063903 A1
(43) Pub. Date: Mar. 11, 2010

(54) HIERARCHICALLY APPLIED RULES ENGINE ("HARE")

(76) Inventors: Thayne Whipple, Ojai, CA (US); Pamela F. Galligan, Castle Rock, CO (US); David Taylor, Springville, UT (US)

Correspondence Address: KANG LIM, 3494 CAMINO TASSAJARA ROAD #436, DANVILLE, CA, 94506, US

(21) Appl. No.: 12/400,514

(22) Filed: Mar. 9, 2009

Related U.S. Application Data
(60) Provisional application No. 61/035,188, filed on Mar. 10, 2008.

(51) Int. Cl. G06Q 10/00; G06Q 40/00; G06F 17/30

(52) U.S. Cl. 705/30; 705/35; 707/607; 707/600; 707/E17.005

(57) ABSTRACT

An electronic transaction decision module is provided that includes a dynamic rules engine, processing system and interfaces to enable various participants in an electronic payment environment to establish and modify the rules, condition values, fees and rewards associated with electronic transactions. Participants in electronic financial or other economic transactions are authorized and enabled to define multiple rules, condition values, fees and rewards within which they either authorize or deny the consummation of a financial transaction and define its impact upon various participants, and to dynamically and efficiently modify those rules, condition values, fees and rewards when desired. Rules, condition values, fees and rewards may be set and evaluated hierarchically based on the participant's relative authority with respect to each attribute. Embodiments of the invention enable the rapid deployment and real-time management of card and mobile payment programs and provide access to card program functions not only by card issuers and program managers, but also by individual cardholders.

### CROSS REFERENCE TO RELATED APPLICATIONS

This application is related to and claims the benefits of Provisional Application No. 61/035,188, filed on Mar. 10, 2008.

### FIELD OF INVENTION

The present invention relates to the field of electronic transaction payments and more specifically to systems and methods for processing electronic transaction payments in which rules related to electronic transactions are conveniently modifiable and in which multiple participants are able to cooperate to efficiently introduce or modify rules, conditions, condition values, timing parameters, fees and rewards impacting the approval or effect of a requested transaction.

### BACKGROUND OF THE INVENTION

The global payment services industry began in the United States during the 1930's when individual firms, such as oil companies and hotel chains, began issuing dedicated credit cards to customers for purchases made at company outlets. The cards used were punched metal cards and later embossed plastic cards. The customer information on the cards was transferred to a paper medium, transmitted to a central office and accounts were manually charged and billed appropriately.

Rules for accepting cards, receiving authorizations for transactions, submitting transaction records and charging accounts were disseminated physically and were manually accomplished.

In 1950, the Diners'Club, Inc. introduced the first universal credit card, allowing their cards to be used at a variety of establishments. Offering convenience and efficiency, universal credit cards increased in popularity as their use became widespread in the 1950's. In 1958, the American Express Company entered the market with their version of a universal credit card.

Bank credit cards were also first introduced in the 1950's and several financial franchises evolved to form today's major credit card companies. In 1966, a group of banks collaborated together to form what is now MasterCard International.

In 1959, the Bank of America in California introduced the BankAmeriCard®. Membership associations were created both in and outside the U.S., and in 1977, the name “VISA®” was adopted internationally. It was the world's first common identity for multi-bank recognition, acceptance, and interchange of value.

MasterCard®, along with American Express®, and VISA®, developed and supported standardized rules, networks and systems for the communication of transactional data.

At this point in time nearly all cards were embossed plastic cards, but transactions continued to be processed manually until a new technology in the form of a magnetic stripe affixed to the card emerged. This magnetic stripe card could interact with an electronic reader, and for the first time it was possible for automatic processing of a transaction.

In response to this innovation, large computer processors were built and electronic networks and devices were implemented to globally link customers, merchants and financial institutions.

In addition, debit cards were introduced in France in the 1960's and grew in popularity across most of Europe. In 1975, NBI introduced the first national deposit access card, enabling cardholders to debit charges from their deposit account rather than having the charge posted to a line of credit.

“Smart cards” that incorporated semiconductor chips and security mechanisms onto credit card-sized cards were also developed in the 1970's. The first mass use of the smart cards was for payment in French pay phones starting in 1983. By the mid 1990's, smart card systems were introduced throughout Europe. American Express introduced Blue® from American Express in 1999, in what was the first wide-scale rollout of smart cards in the United States.

“Pre-paid cards” have also been introduced as a convenient mechanism to allow cashless transactions to be initiated by individuals who may have no existing banking relationship such as those typically required in order to support a credit card or debit card. Pre-paid cards can be either funded on a one-time basis or be replenishable in nature, and have been growing in their usage in the form of gift cards, cafeteria cards, refund cards, as well as a convenient employer payment mechanism.

To support and enable the explosion of electronic transactions and the corresponding volume of commercial data, banks and other organizations involved in transaction processing run extremely fast and powerful computers with specialized software systems. However, while the technologies that currently support core payment processing were designed to be reliable, fast and functional, they are not flexible or adaptable to changing circumstances. Most programs rely on large legacy processing systems that are expensive, difficult to access, slow to respond and cumbersome and expensive to change.

Prepaid card processing systems today are typically legacy systems that have been modified from systems designed for use with credit and debit cards. However, the needs of prepaid card transaction processing are quite different from systems that extend short-term loans (credit) or access existing bank accounts where other activity is also supported (debit). Frequently, these systems are operated by third party processors with systems written to meet the lowest common denominator in requirements and lack the flexibility to support true differentiation of programs. In this legacy environment, electronic card programs require lengthy lead times to make simple changes, require programmers to implement them, and potentially cost the program participants thousands of dollars in expenses and lost opportunity and customers. Efficient implementation and rapid adaptability are essential to ensuring success in the prepaid card market—or any electronic payment space.

“One Size Fits All” bank card products miss substantial market segments; and lack attractive, value-add and “learned behavior” features that can motivate consumers to use their cards in ways profitable to the card issuer. Issuers have recognized this problem; for example, there are currently 15 different product types on Visa's prepaid program application alone, ranging from open loop, reloadable general spend cards to payroll cards to benefits cards to teen cards to closed loop single-merchant gift cards. Each of these product types has its own set of operational conditions and fees. However, legacy transaction processing systems are ill suited to provide the flexibility to support rapid program innovations, and are typically designed to meet the needs of the lowest common denominator program. The opportunities associated with programs customized to meet the needs of selected target populations are too frequently missed because tailoring the program conditions is time consuming, cumbersome, expensive and often within the control of a third party processing organization.

In addition, marketing and sales of bank card products can be expensive and labor-intensive and risk management has become increasingly complex as technology has enabled fraudsters to mount constantly changing attacks.

A large number of different participants or interested parties can exist in a modern electronic transaction, including for example, a financial institution that is a card issuer (e.g., a customer's bank), a financial institution that is a card acquirer (e.g., a merchant's bank), a network or networks, an association such as Visa, MasterCard or Discover, a program manager such as an ISO, MSP, or other designated program agent (that may take on specific roles in the card program like card management, sales, or sales of services like point-of-sale terminals and connectivity to merchants), a sub-program manager that could also be an ISO, MSP, or other designated program agent (that may work with program agents to re-sell cards, for example), a merchant, a cardholder, a Shopping Cart or Virtual POS operator, and potentially others.

Typically, changes to legacy transaction processing systems require re-engineering, re-compilation, renewed quality assurance testing and re-certification of the software code.

A series of detailed agreements are typically instituted between the various participants in an electronic transaction system to define the rules that govern the operation of the system and the rights of and relationship between the participants. The rules are implemented at various places within the system to enable the transaction processing system to operate rapidly and reliably.

“Card” as used in this discussion is to be understood to include cards, chips, smart phones, PDAs, or other electronic devices or techniques that are utilized by a customer to initiate a transaction. Most cards simply provide data that is utilized by the system in a rules process, but do not process rules in and of themselves. “Smart” cards in the form of an IC chip, or similar device, often have rudimentary rules intelligence in terms of approving or denying the device with which it is interacting and perhaps approving or denying a transaction based on the monetary value balance stored in a ‘purse’ or database. The customer cannot electronically determine the terms of the transaction, however, other than to authorize the transaction to commence or not, and with respect to stored value balances, the customer can add to or withdraw funds.

Devices such as ATM (Automated Teller Machine) and POS (Point of Sale) devices typically contain a processor running software that allows them to interact between cards and Transaction Gateways/Networks (described more fully below). Devices can also be in the form of phones, PDAs, server or personal computers, and other electronic devices that run specialized software. Although there may be some direct communication by and between a device and card, the most common application involves the reading of data from the card by the device. Data from a card may be interpreted in accordance with rules implemented and resident on the device, and data from cards not immediately denied network access may be transmitted, together with the terms of the transaction, to a Transaction Gateway/Network. The terms of the transaction are defined using pre-set input criteria that are communicated to the device either manually by the customer or electronically. The terms of the transaction typically include price and, often, secondary customer authentication data.

The primary role of a Transaction Gateway/Network is to transmit properly formatted data concerning a requested transaction from a device to a Transaction Processor (described more fully below). Some Transaction Gateways/Networks additionally employ some level of business logic to ensure that messages are formatted correctly and to verify PINs and other card identification information such as Card Verification Values.

Transaction Processors are systems and enterprises in an electronic transaction system that act as service providers to the financial institutions and networks and support both the merchants and the customers in the transaction. This is accomplished by applying and enforcing pre-defined rules and data formats determined by associations (such as Visa, MasterCard, STAR, etc.) as well as financial institutions and program managers, for each discrete transaction. Transaction processors have typically implemented and applied a limited amount of rules logic in the transaction processing cycle, including for example, fee assessments, comparisons against fund balances or credit limits, verification against other limit types, and other pre-determined criteria. However, such rules logic was typically hard-coded into the software code of the transaction processor and not readily extensible or modifiable, and subject to control by only the participant responsible for operating the transaction processor.

Account Databases are often managed by transaction processors, but may also be managed by financial institutions. Based on approved transactions, accounts are updated with a financial balance.

Each participant and each component in the payment process has an important role to play and rules and interfaces have been introduced in the system that allow the overall system to work efficiently and reliably.

However, a flexible, comprehensive technological approach has not been offered to link the many participants of an electronic transaction in order that they might dynamically and hierarchically participate in the decision making process for establishing and efficiently modifying transactional rules, conditions, condition values, timing parameters, fees and rewards.

### SUMMARY OF THE INVENTION

An embodiment of the invention provides a simple-to-use system and method and presents interfaces through which one or more of the key participants to an electronic transaction are authorized and enabled to view, add, modify or delete the rules, conditions, condition values, timing parameters and notification requests by which automated transaction approval or disapproval decisions are made, and fees and rewards associated with an electronic transaction are allocated among participants. Additions and/or modifications to such rules, conditions, condition values, timing parameters, notification requests, fees and rewards may be maintained as data in a database management system and become operational almost immediately upon entry without the need for changes to software code, and with a much reduced likelihood of a need to re-certify the transaction processing system.

Another embodiment of the invention introduces a system and method that accepts standardized electronic transaction messages, interprets and applies those messages using rules, conditions, condition values, timing parameters, notification requests, fees and rewards created by a plurality of the participants to an electronic transaction and responds with the necessary information to create a standardized electronic transaction message that accurately communicates the intended result of the transaction based on the application of the associated rules, conditions, condition values, timing parameters, notification requests, fees and rewards. Rules, conditions, condition values, timing parameters, notification requests, fees and rewards can be created in embodiments of the invention based on any data element in an ISO 8583 or other standardized message format.

Embodiments of the invention can operate either on a stand-alone basis, or integrated into a traditional transaction processor. Thus, the invention is able to operate within the existing infrastructure of current transaction processing systems.

The invention provides a simple to use mechanism by which the consumer, merchant, and/or transaction professionals can interact with one another dynamically to define and modify the rules, conditions, condition values, timing parameters, notification requests, fees and rewards of electronic transactions.

The invention introduces a set of tools, software, procedures, protocols, and databases to enable participants of an economic transaction to dynamically relate to each other.

The present invention offers intelligent and convenient management tools to permit the authorization and enablement of each participant in an electronic transaction to define rules, conditions, condition values, timing parameters, notification requests, fees and rewards under which they desire to enter into or not enter into an electronic transaction. Interfaces for multiple participants are provided to enable access to the database of a decision module, and a hierarchical relationship defining levels of authorizations or permissions for each participant is preferably defined with respect to rules, conditions, condition values, timing parameters, notification requests, fees and rewards.

In embodiments of the invention, because program changes can be made in the decision module, they can be made by authorized participants online and in real time without requiring system re-certification. This real-time flexibility puts control in the hands of business decision makers and cardholders and frees up scarce software programming resources.

As a result, card programs can quickly be built from the ground up with a very broad or narrow customer base in mind. Also, subgroups within card programs can be addressed to capture true one-to-one marketing opportunities.

Participants such as program managers can utilize embodiments of the invention to adjust time sensitive conditions, such as fees and rewards, in a real-time environment. Special offers can be launched and terminated quickly and efficiently. Cardholders, as well as card issuers and program managers, are able to manage, customize and control individual accounts. For example, cardholders can utilize embodiments of the invention to control how their individual accounts are used: for example, with which merchants, in which geographic locales, for which type of purchases, and at what dollar limits (per transaction or in total).

### BRIEF DESCRIPTION OF THE DIAGRAMS

The figures are meant to be representative of the invention, and illustrative of various embodiments thereto. It should be understood, however, that the invention is not limited to the precise arrangements and instrumentalities shown in the drawings.

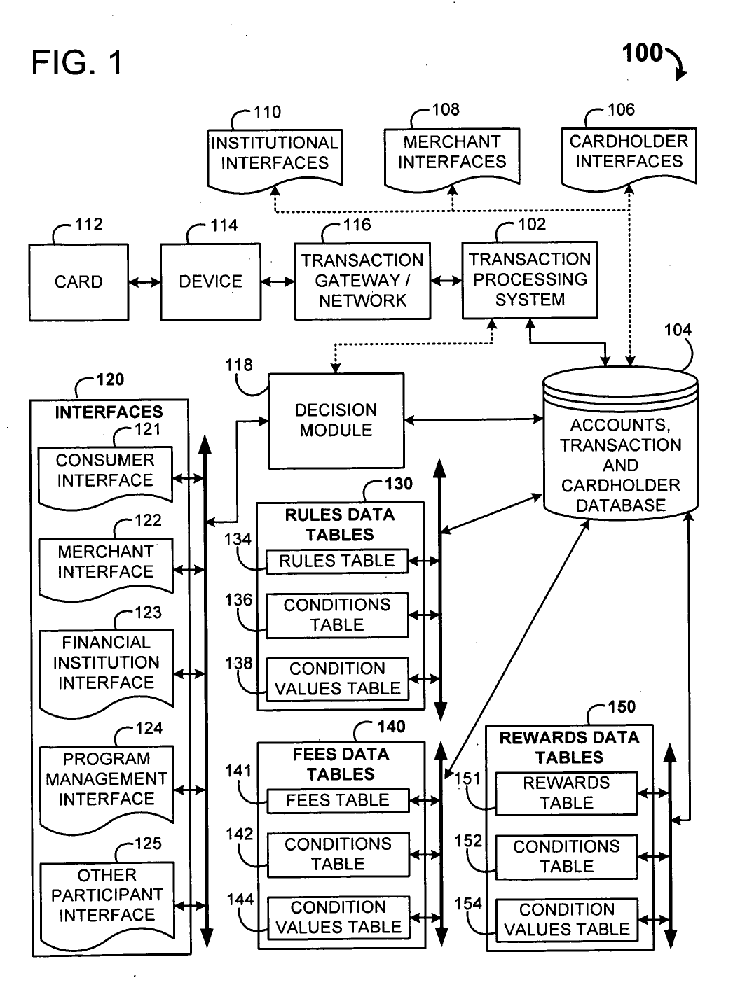

FIG. 1 is a general overview of the components of and participants to an electronic transaction including an embodiment of the invention in which a decision module interfaces to a transaction processing module of an electronic transaction processing system.

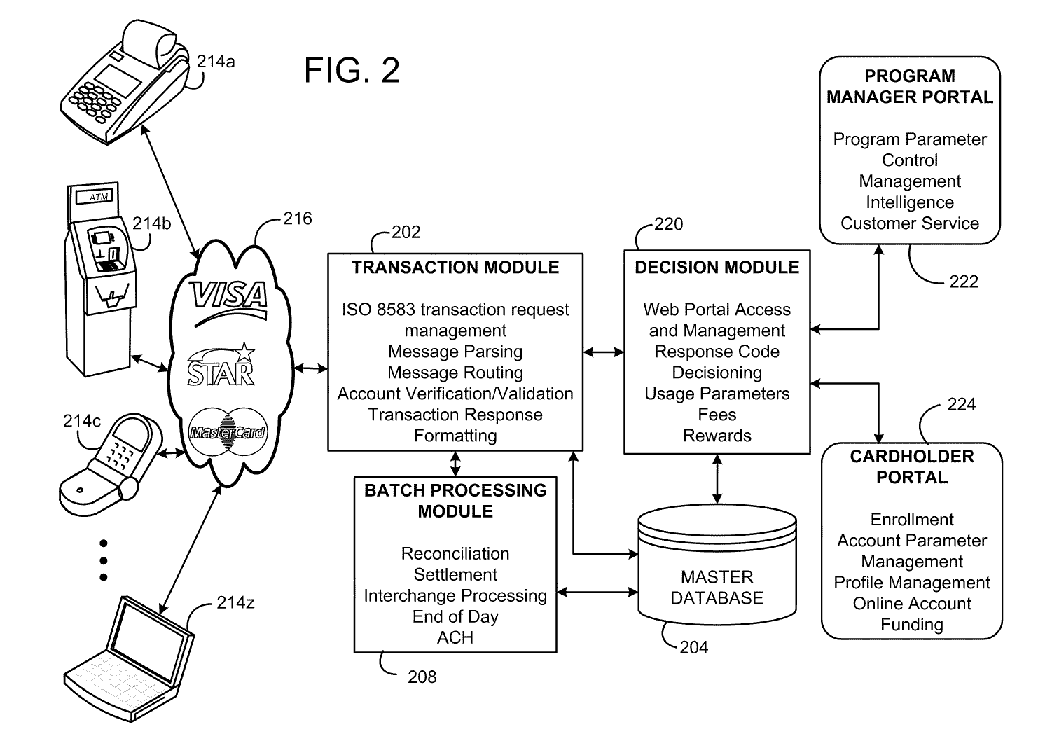

FIG. 2 is a diagram of an embodiment of the invention in which a decision module provides a Program Manager Portal and a Cardholder Portal as interface mechanisms.

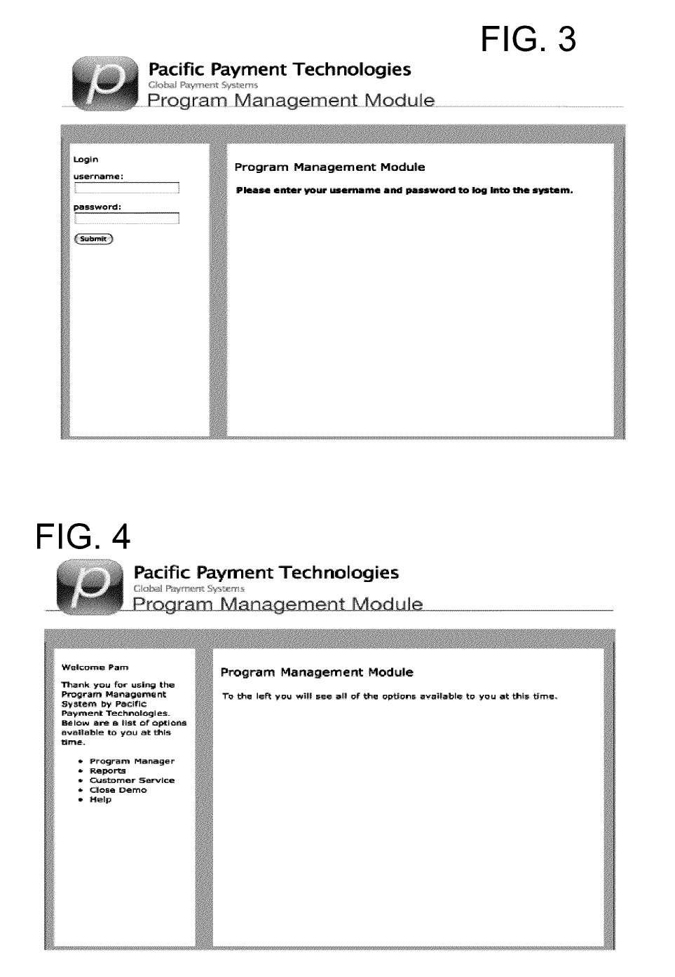

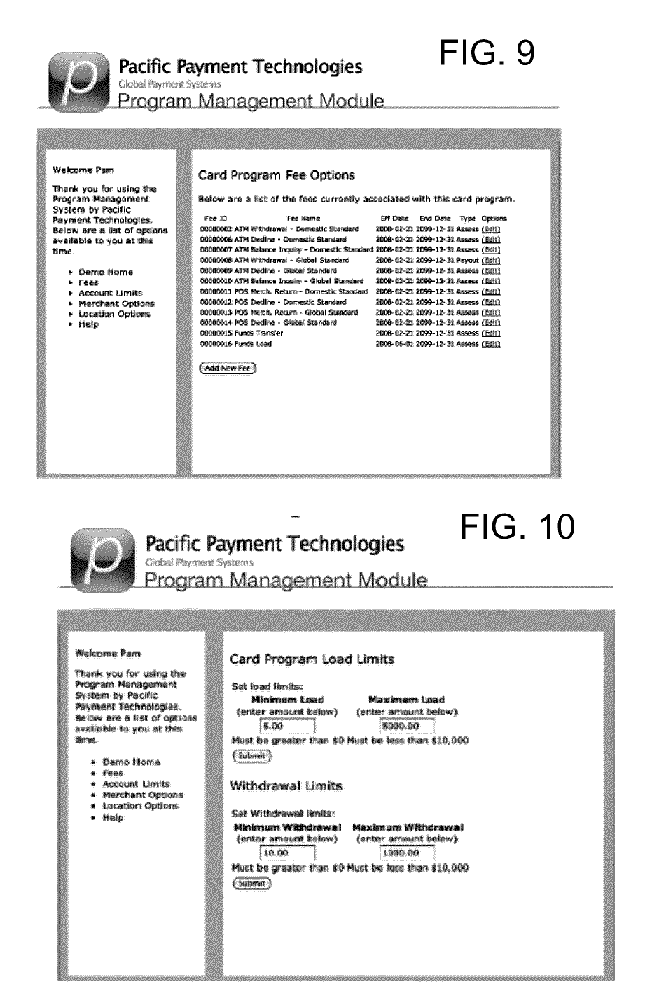

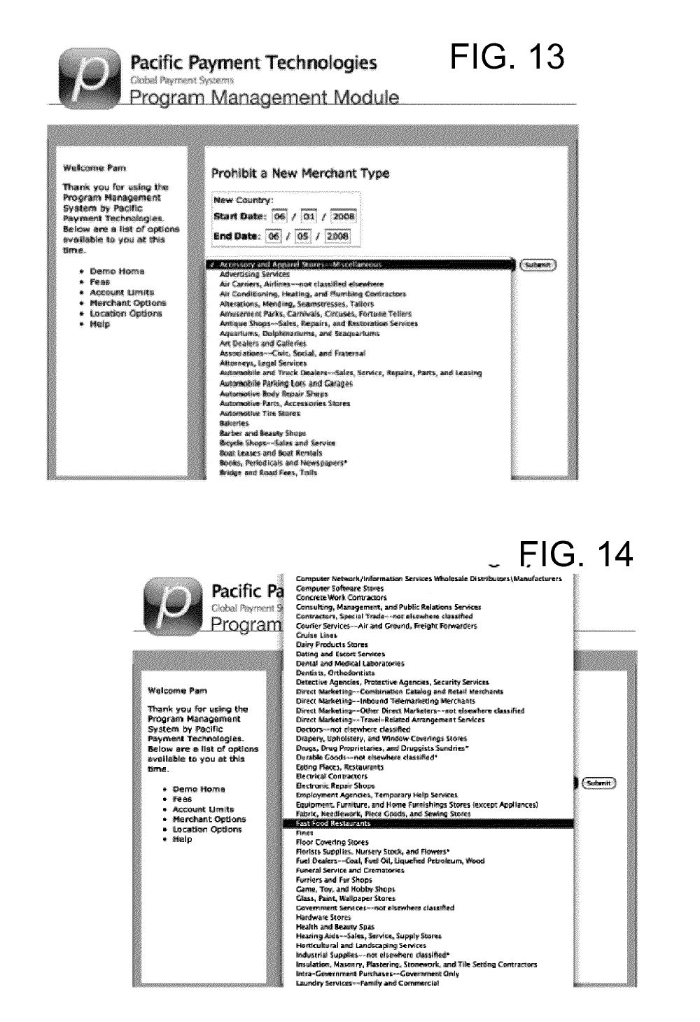

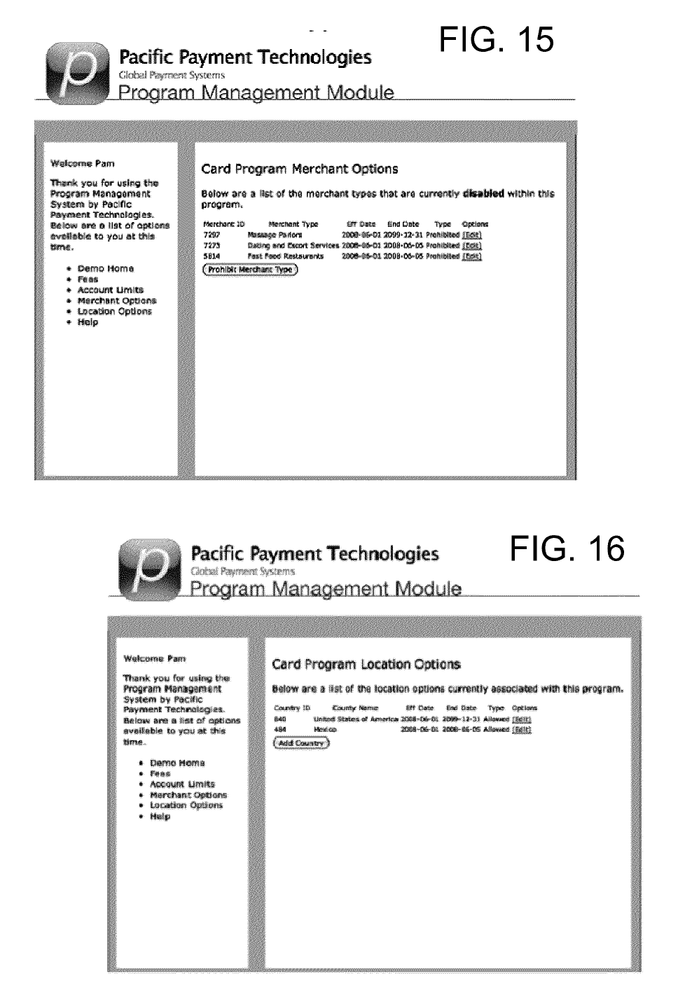

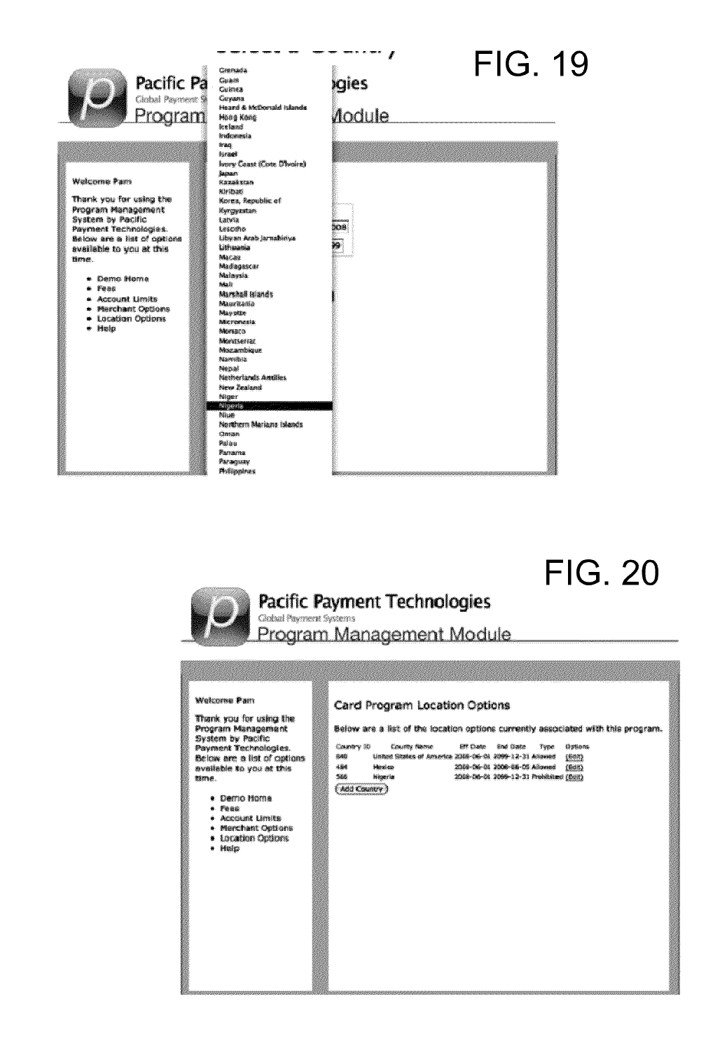

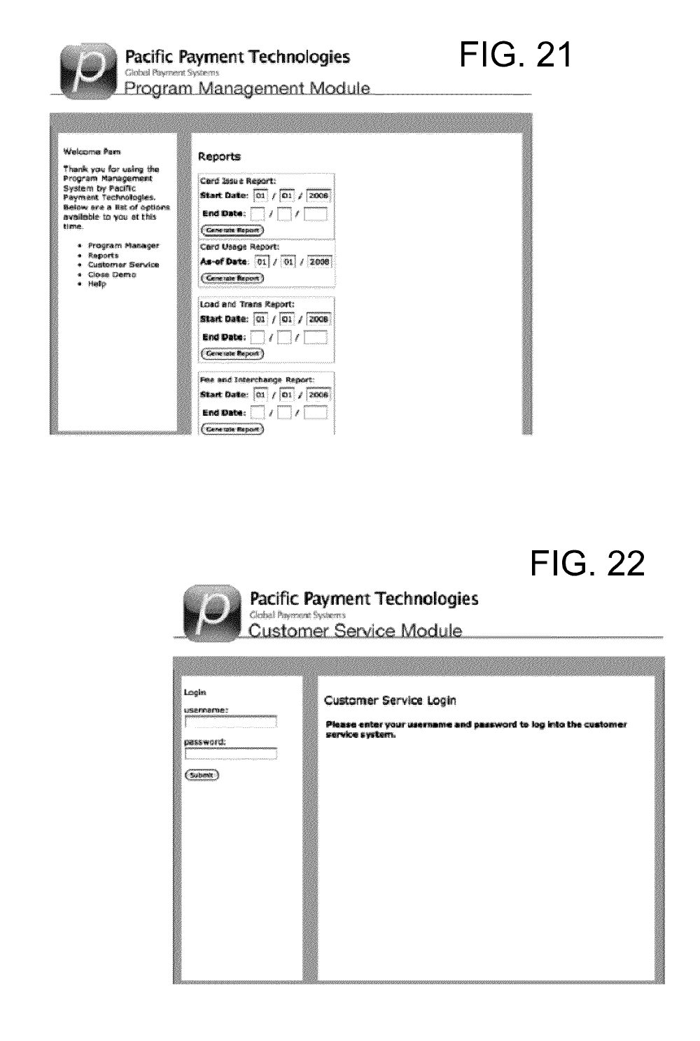

FIGS. 3 through 21 are screen displays illustrating various functions of the program management module of an embodiment of the invention.

FIGS. 22 through 24 are screen displays illustrating various functions of the customer service module of an embodiment of the invention.

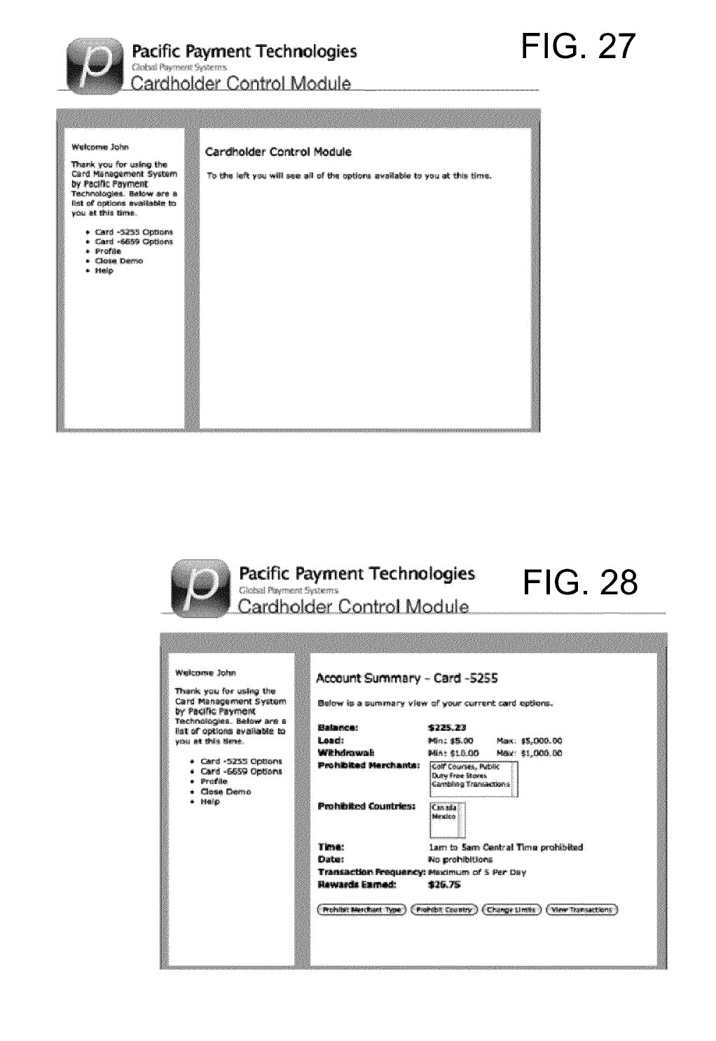

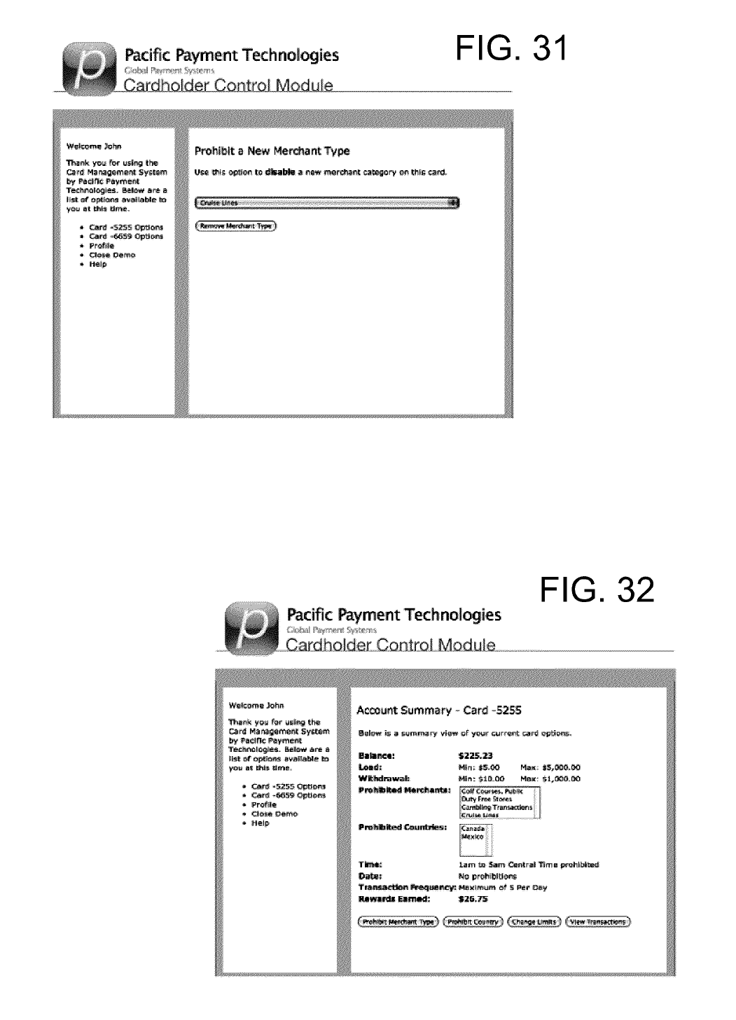

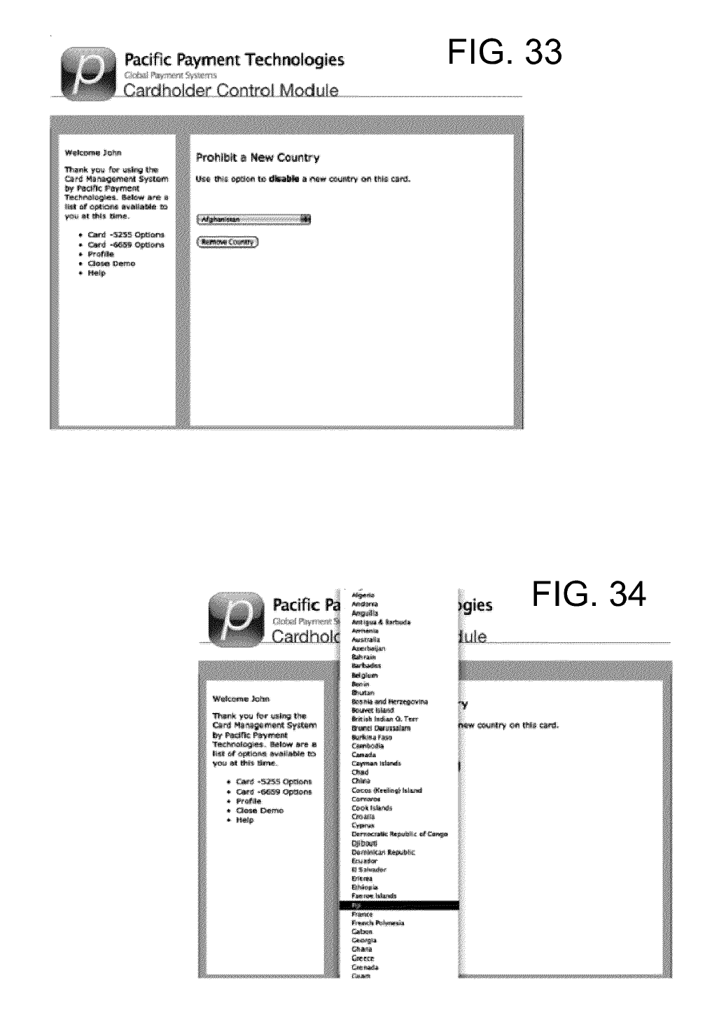

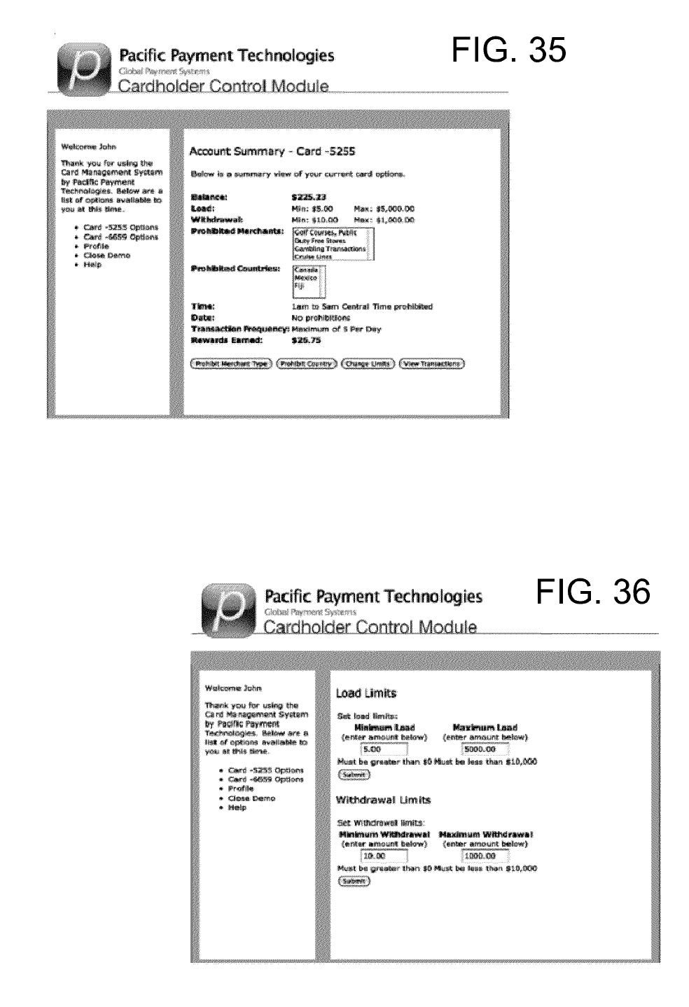

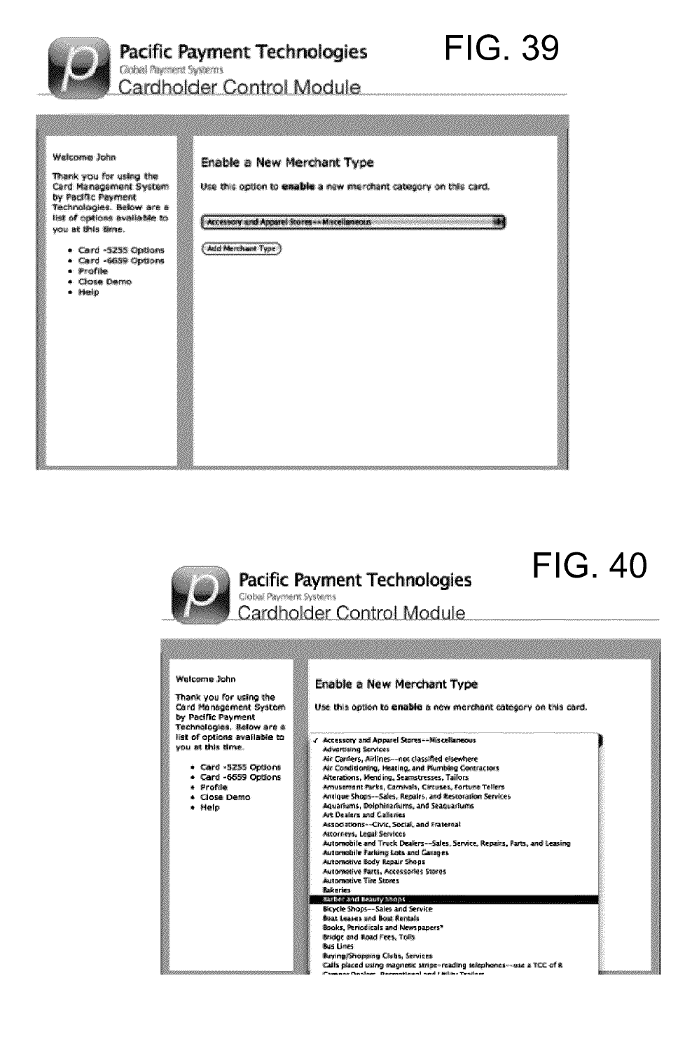

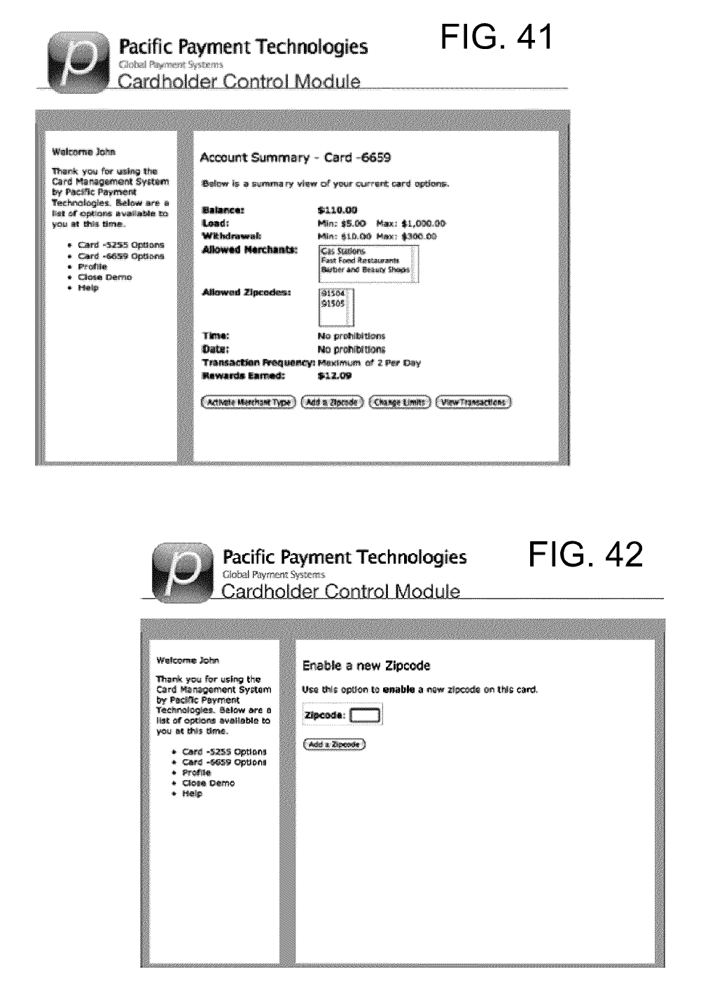

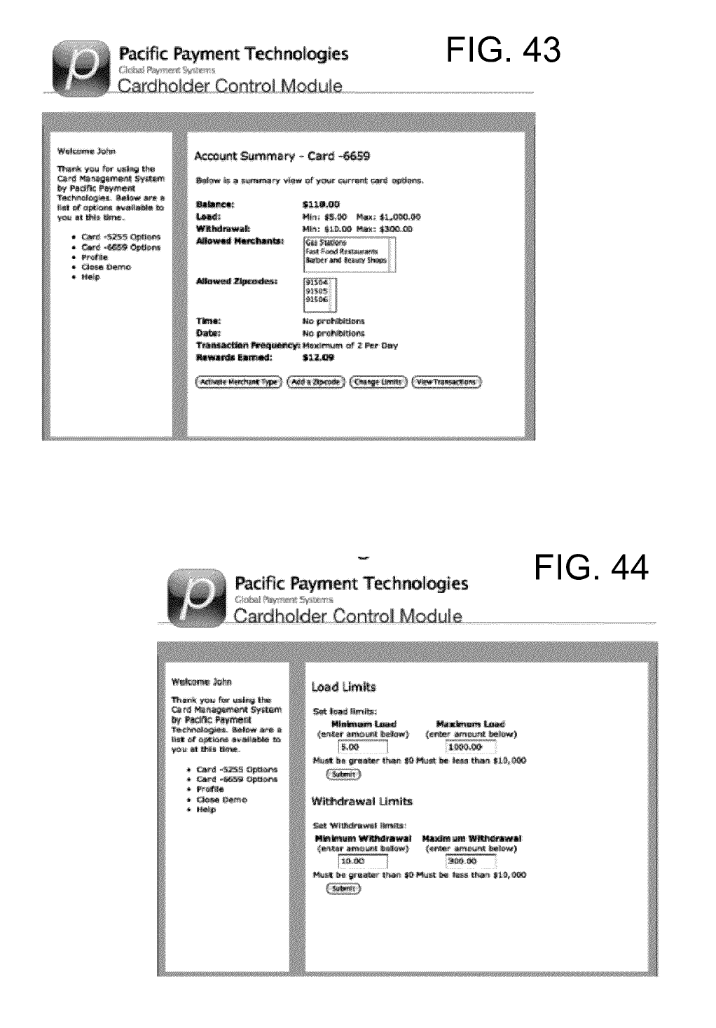

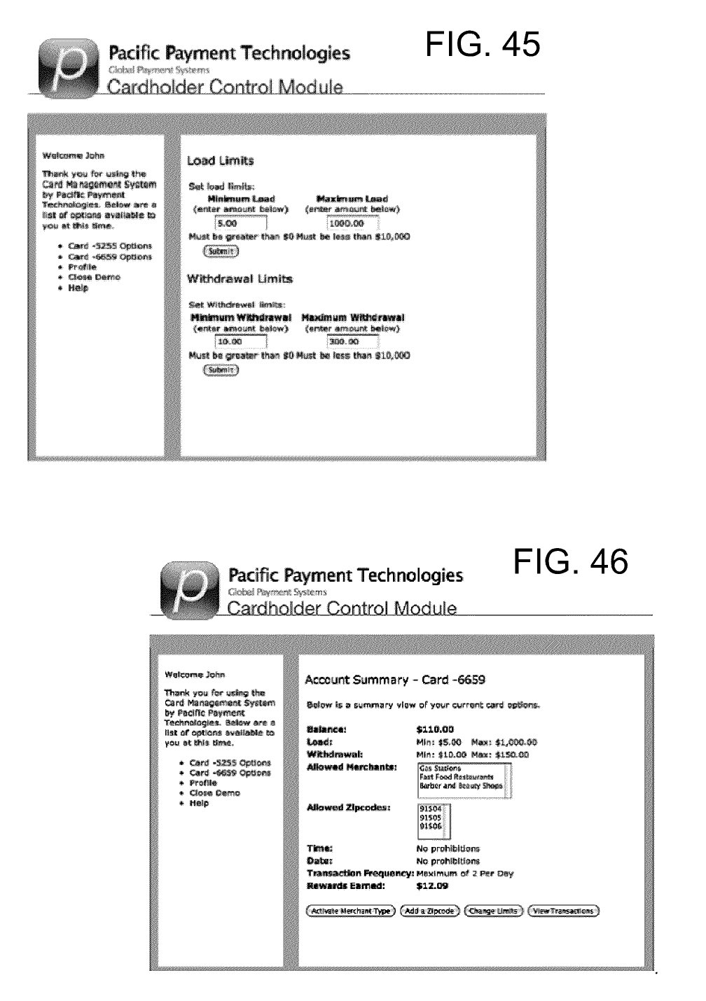

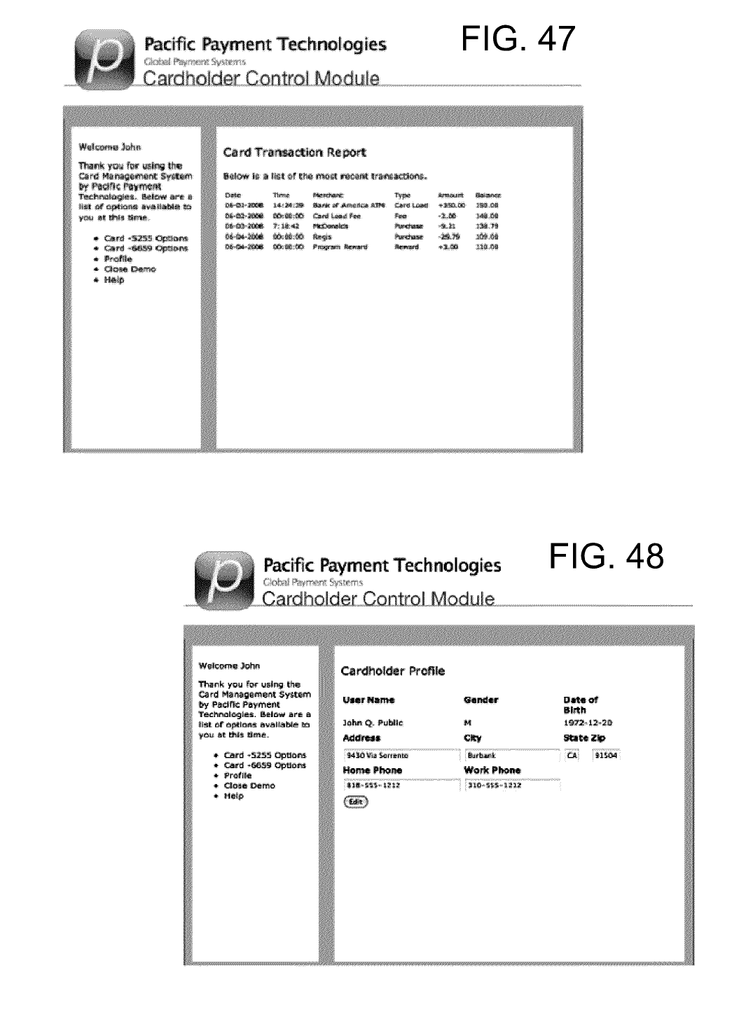

FIGS. 25 through 48 are screen displays illustrating various functions of the cardholder control module of an embodiment of the invention.

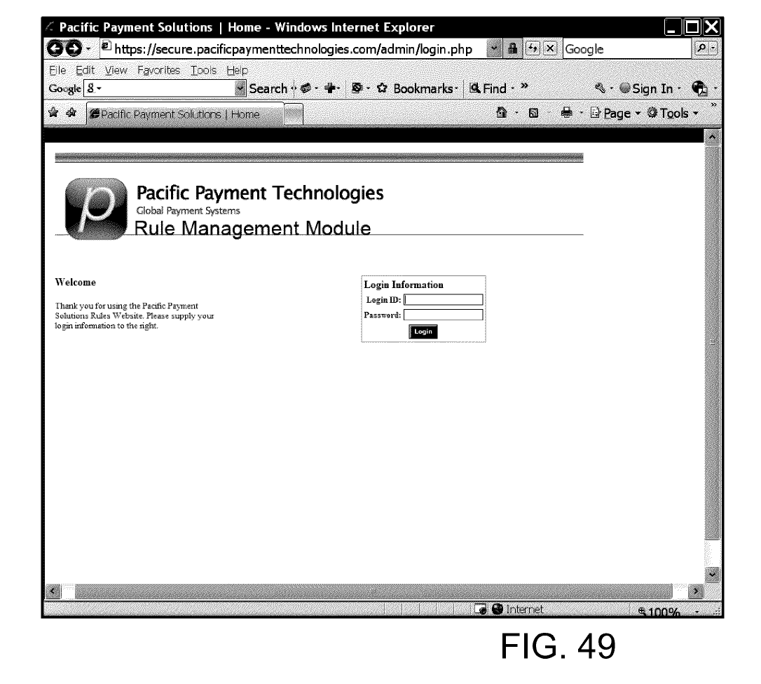

FIGS. 49 through 64 are screen displays illustrating various functions of the Rules Management module of an embodiment of the invention.

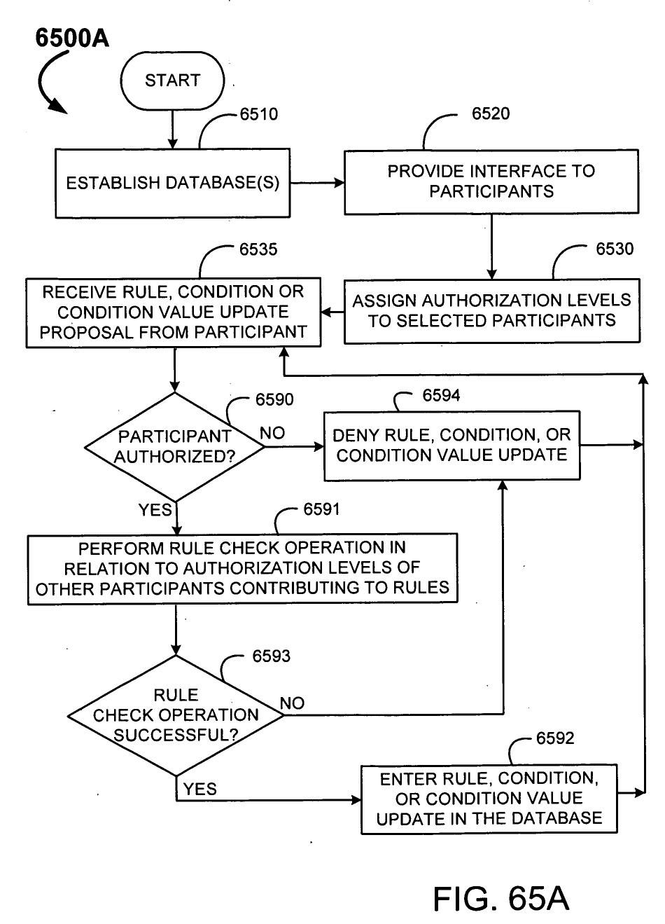

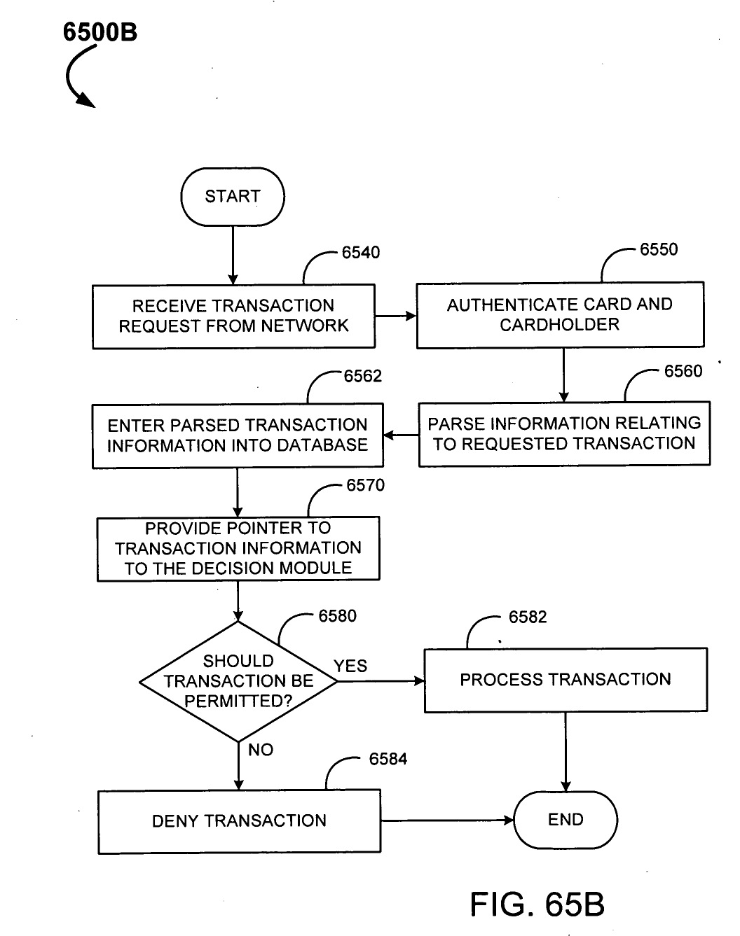

FIGS. 65A and 65B are exemplary flowcharts for the operation of the electronic processing system in accordance with an embodiment of the invention.

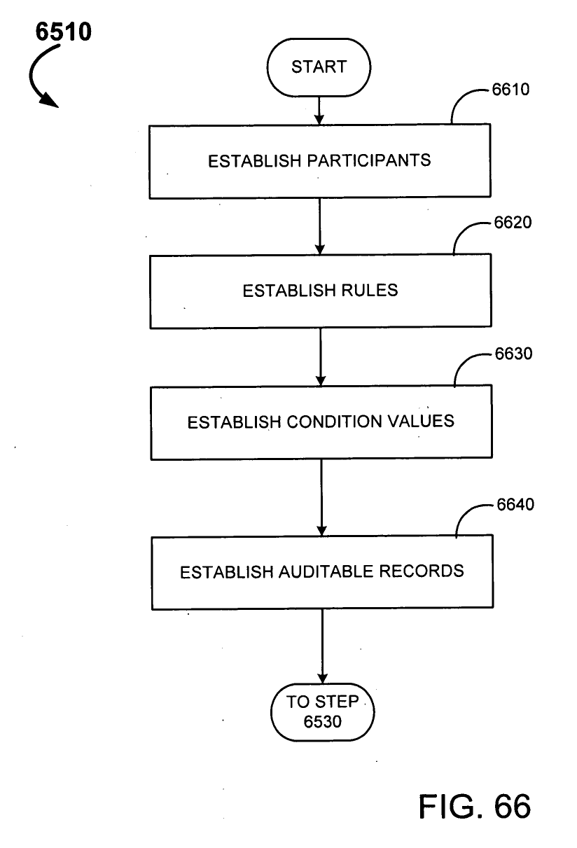

FIG. 66 is an exemplary flowchart for establishing databases for the operation of the electronic processing system in accordance with an embodiment of the invention.

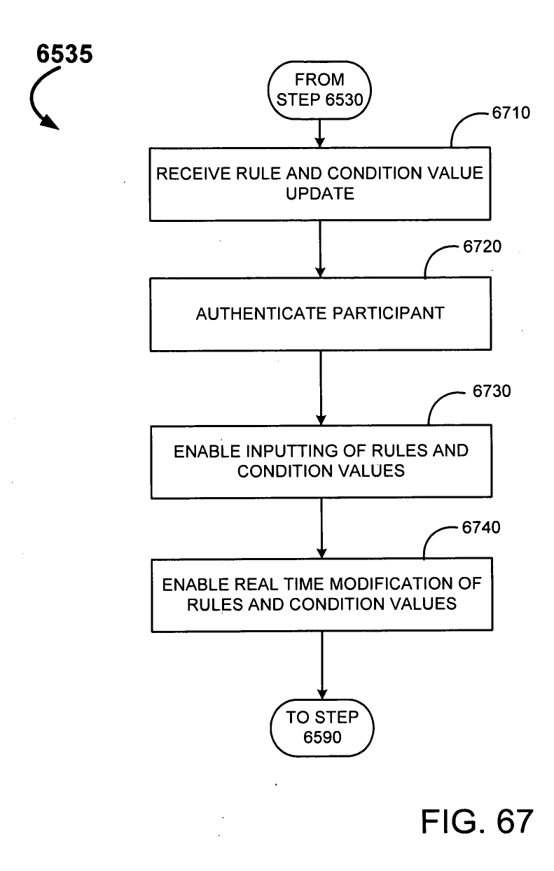

FIG. 67 is an exemplary flowchart for providing an interface to the participants for the operation of the electronic processing system in accordance with an embodiment of the invention.

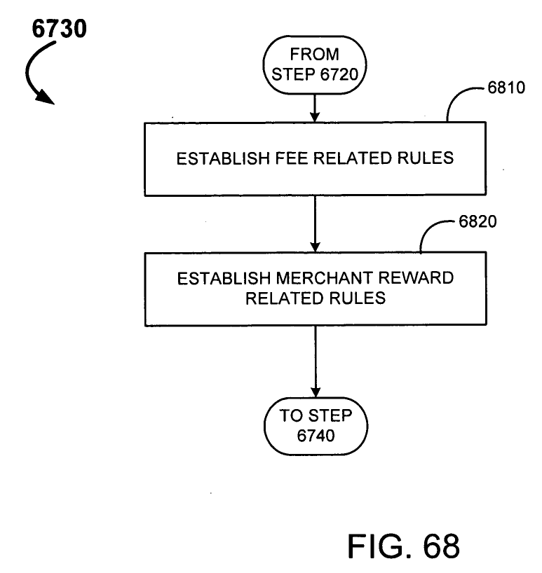

FIG. 68 is an exemplary flowchart for enabling the input of rules and condition values for the operation of the electronic processing system in accordance with an embodiment of the invention.

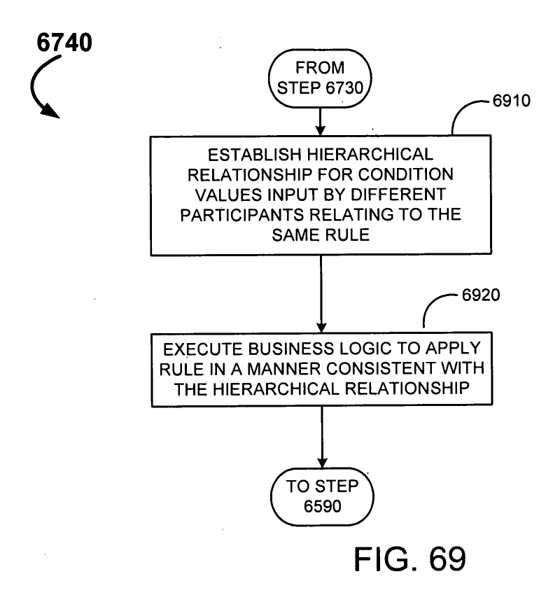

FIG. 69 is an exemplary flowchart for enabling the modification of rules and condition values for the operation of the electronic processing system in accordance with an embodiment of the invention.

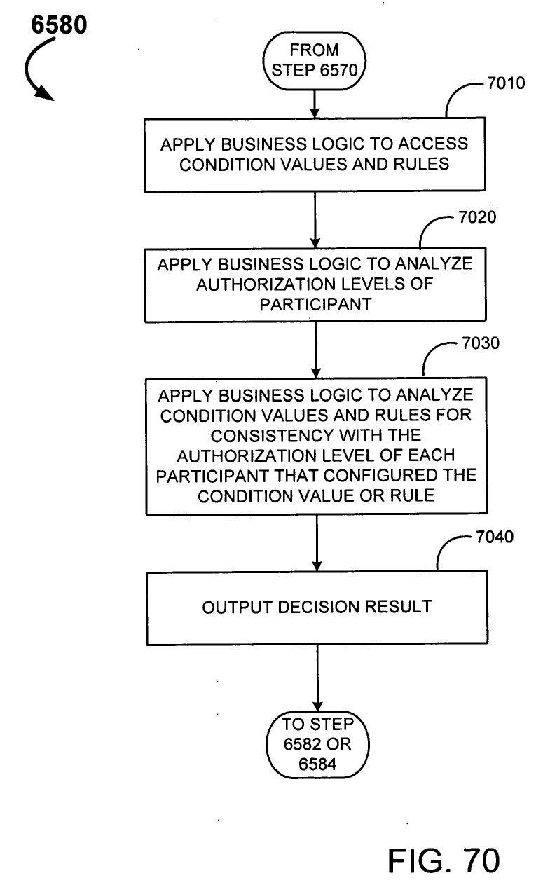

FIG. 70 is an exemplary flowchart for determining if a transaction should be permitted for the operation of the electronic processing system in accordance with an embodiment of the invention.

### DETAILED DESCRIPTION OF THE DIAGRAMS AND EMBODIMENTS

The embodiments described below are intended to be illustrative in assisting interested parties to understand the invention and the uses to which it may be put. It should be understood, however, that the invention is not limited to the precise arrangements and instrumentalities described in the embodiments.

Embodiments of the invention permit:

a) Control over the various rules, fees and rewards, and associated timing parameters, notices, conditions and condition values, of an electronic transaction to be selectively and controllably distributed among participants in the transaction.

b) Flexibility to participants by allowing real-time modifications to rules, fees and rewards, and associated timing parameters, notices, conditions and condition values, governing an electronic transaction.

c) Authority to modify rules, fees and rewards to be distributed in a flexible framework to multiple participants of a transaction, and modifications to be applied in accordance with an authorization hierarchy.

FIG. 1 is illustrative of the general use of the invention and how it may be implemented to interface effectively to payment technology systems that may be currently in use.

As shown in FIG. 1, an electronic transaction payment system 100 includes a transaction processing system 102 that communicates with an account, transaction and cardholder database 104. Database 104 typically includes up-to-date information concerning the account status of a set of cardholders, including for example, the checking account balances of debit cardholders or the credit balances of credit cardholders. Database 104 typically also can be accessed, at least for informational purposes, directly or indirectly through a cardholder interface 106, a merchant interface 108 and institutional interfaces 110.

In the course of a typical requested transaction, a card 112 such as a credit card, debit card or pre-paid card interacts electronically with a device 114 such as an ATM or card reader at a merchant site to capture and format specific information concerning the transaction and participants and transfer that information through a transaction gateway/network 116 to transaction processing system 102.

Prior to the introduction of the present invention and in the absence of the decision module 118 and certain attributes of database 104 described herein, a transaction processing system 102 would traditionally have communicated with an account database to verify/validate the identity of the cardholder and thereafter applied a limited and predefined set of hard-coded rules to the data associated with a requested transaction, e.g., to determine if sufficient funds were available for the requested transaction, and if so, implemented the transaction through a series of electronic actions, including debiting the account of the cardholder, crediting an account of the merchant (if one was involved in the transaction) and calculating and allocating fees associated with such transaction to and among other participants to the transaction.

Significantly, prior to the introduction of the present invention, the rules, fees and rewards and associated conditions, condition values, timing parameters and notification requests governing the approval criteria for a requested transaction, and the impact of that transaction upon the various participants, would have been pre-established and fixed according to written agreements between various participants and/or dictated by one of the participants such as the card issuer or financial institution, then written into the software code that constituted the transaction processing 102. In any event, such rules, fees and rewards, and associated timing parameters, notification requests, conditions and condition values were not generally flexibly and controllably alterable by one or more of the participants to the transaction.

As a result of banking industry requirements, including those imposed by banking associations such as VISA, MasterCard and STAR, it was required that the capability, reliability, and security of a transaction processing system 102 be certified by way of a time consuming and costly certification process, before such a transaction processing system could become operational in cooperation with a transaction gateway/network 116. Any significant changes to such transaction processing system 102, including for example any changes that introduced support for a new type of transaction or that required a recompilation of the software code of transaction processing system 102, also required that a re-certification process be completed before such changes could be attached to a transaction gateway/network 116.

According to an embodiment of the invention, in FIG. 1 there is shown a decision module 118 that includes business logic for implementing a rules engine, to which multiple representative electronic interfaces 120 may be provided for some or all of the participants to the requested transaction. Security mechanisms of a known type such as passwords, firewalls and IP-address based approaches may be associated with the use by participants of electronic interfaces 120, and a varying scale of security mechanisms may be deployed in conjunction with a hierarchical relationship of permissions and authorizations of participants. For example, participants that enjoy a higher level of permission or authorization to add or modify rules, conditions, condition values, timing parameters, notification requests, fees and rewards, as more fully described below, may have a higher level of security associated with their accessing of the decision module 102 and/or other elements of the system.

Decision module 118 also communicates electronically with database 104 (and its associated rules data tables 130, Fees data tables 140 and Rewards data tables 150). The rules data tables 130 may include any of a rules table 134, a conditions table 136 and a condition values table 138. The Fees data tables 140 may include any of a fees table 141, a conditions table 142 and a condition values table 144. The rewards data tables 150 may include any of a rewards table 151, a conditions table 152 and a condition values table 154. Decision module 118 may also communicate electronically with a data tables for maintaining, in an auditable form, data from the electronic input messages received by decision module 118 from transaction processing system 102, and the electronic output messages transmitted by decision module 118 to transaction processing system 102 decision module 118 in response thereto. It should be appreciated that the details of the implementation of the database 104 accessible to decision module 118 are understood by those having skill in the field. By the application of such skill, multiple conceptual databases may be incorporated as tables in a single database, and a single conceptual database may be implemented as multiple databases.

Decision Module 118 operates in the embodiment shown in FIG. 1 to apply and implement through business logic, the rules, conditions, condition values, timing parameters and notification requests that relate to and define the approval criteria associated with a requested transaction. Decision Module 118 also preferably operates to apply and implement through business logic, the conditions and condition values that relate to and define the fees and rewards associated with a requested transaction to the various participants of the transaction.

Decision Module 118 may be implemented in the form of software or machine instructions hosted and executed on a general purpose computer such as a secure server. Firewall and encryption hardware and/or software can be deployed to provide for appropriate levels of security. Communications may be enabled through dedicated telephone lines and/or access to the Internet. The software can be designed to accept standardized transaction message data, including ISO 8583 message formats, from the transaction processing system 102; analyze those messages and return standardized transaction message data, appropriate for ISO 8583 message formats, indicating to the transaction processing system 102 whether a transaction should be approved, denied or other message should be generated and transmitted to a participant.

As shown in FIG. 1, decision module 118 may be implemented as a separate module of software that is compiled to form a distinct unit of executable code that communicates with transaction processing system 102 and database 104 through well-defined software interfaces, as known to those of skill in the art. In this manner, changes made to the decision module 118 do not require re-compilation of the transaction processing system 102 and are much less likely to require a recertification of the system. Communications to and from decision module 118 can be implemented through a dedicated telephone line using TCP/IP protocol, directly networked servers, through a secure and encrypted Internet connection, or other any other mechanism known to be effective.

Internet connection to any of the sub-modules of the decision module 118 can be secured by firewalls and/or encryption devices or techniques.

Each participant to an electronic economic transaction may be enabled and authorized to interact with the decision module 118 through a standard or custom user interface that allows any enabled and authorized participant to add, modify or delete rules, conditions, condition values, timing parameters, notification requests, fees and/or rewards, which will guide and impact the participant's economic transactions. Depending upon the rule, condition, condition value, fees and/or rewards involved, enabled and authorized participants could include:
a. A financial institution (e.g., Issuing Bank)
b. A financial institution (e.g., Acquiring Bank)
c. A network or networks
d. An association (e.g., VISA, MasterCard, STAR)
e. A program manager (ISO, MSP, or other designated program agent)
f. A sub-program manager (ISO, MSP, or other designated program agent)
g. A merchant
h. A cardholder
i. Shopping Cart or Virtual POS operator
j. Another principal to the transaction

Decision module 118 utilizes database 104 to store information relevant to each participant authorized and enabled to use the system. Database 104 preferably includes a data table that is established in the system to define a hierarchical relationship between and among each participant that is enabled by the system to input and/or alter any rule, condition, condition value, timing parameter, notification request, fee or reward that might apply to a requested transaction. For example, for a particular rule relating to the maximum permissible dollar value of a single transaction, multiple participants to the transaction may be empowered by the system to input or alter the associated condition or associated condition value, including an issuing bank, an acquiring bank, an association, a cardholder and a merchant. In one embodiment of the invention, a hierarchical relationship between such participants for such condition and associated condition values can be established in a data table, for example with the issuing bank occupying the highest level in the hierarchy, the program manager at the next level, the sub-program manager at the next level, and the cardholder at the lowest level. Hierarchical relationships can be established and applied on a global basis (i.e., with respect to all rules, conditions, condition values, fees and rewards), on an item-by-item basis (i.e., potentially a hierarchical relationship for each rule, condition, condition value, fee and/or reward), or more commonly on a grouped basis (in which one group of rules, conditions, condition values, fees and rewards are defined to a first hierarchical relationship and another group to another hierarchical relationship).

Rules Data Tables 130 may accept input from all authorized and enabled participants to an electronic economic transaction and the database management system organizes and stores such input within appropriate tables relating to the category of rule, condition, condition value, timing parameter, notification request, fee and/or reward referenced.

Decision module 118 may also utilize Fees data tables 140 to store information relative to the fee categories and associated conditions and condition values that might be relevant to a requested electronic transaction.

Fees data tables 140 preferably accepts input from all authorized and enabled participants to a requested electronic transaction and the database management system organizes and stores their input within tables relating to the category of fee(s) referenced.

Decision module 118 may also utilize Rewards data tables 150 to store information relative to the reward categories and associated conditions and condition values that might be relevant to a requested electronic transaction. Rewards data tables 150 preferably accepts input from all authorized and enabled participants to an electronic transaction and the database management system organizes and stores their input within tables relating to the category of reward(s) referenced.

Thus, by utilizing a series of database structures with associated tables, authorized and enabled participants to an electronic transaction can access the decision module data through either web-based, dedicated telephone line, or physical or wireless network interfaces to add, modify, or delete rules, conditions, condition values, timing parameters, notification requests, fees and rewards, preferably in a hierarchically-applied, permission-based approach as discussed more fully below.

When a transaction is initiated electronically, the details of the transaction are submitted to and compared by the decision module 118 to the appropriate data tables in Rules data tables 130, Fees data tables 140 and Rewards data tables 150. Rules engine retrieves all rules, condition values, fees and rewards for a requested transaction. In the event that multiple entries for a particular one of such data entries been identified, rules engine also accesses the data table containing the data relating to the hierarchical relationship for such data item and applies business logic to decide upon the approval or disapproval and applicable fees and rewards associated therewith, in accordance with the hierarchical relationship defined. Decision Module 118 then preferably transmits an XML-standardized message to the transaction processing module where it is re-formatted into a standard ISO message that instructs the participants with respect to the results of the transaction (approved, denied, fees applicable, rewards earned, etc.).

Participants may access the transaction system through one or more interfaces 120. These interfaces may include, but are not limited to, a consumer interface 121, a merchant interface 122, a financial institution interface 123, a program management interface 124 and any other participant interface 125. Participants with access through the interfaces 120 to the decision module 118 and its associated databases could include:
a. A financial institution (Issuing bank)
b. A financial institution (Acquiring bank)
c. A network or networks
d. An association
e. A program manager (ISO, MSP, or other designated program agent)
f. A sub-program manager (ISO, MSP, or other designated program agent)
g. A merchant
h. A cardholder
i. Shopping Cart or Virtual POS operator
j. Other participants to the transaction

Systems that could interact either directly or indirectly with the Rules Engine 122 and its associated databases could include:
a. Cards
b. Devices
c. Gateways
d. Networks
e. Processors
f. Account Databases

Rules and conditions that can be controlled by authorized and enabled participants could include the following examples:

FEES

### 1) Transaction Fees

ATM withdrawal fee (foreign or domestic)
ATM transaction fee other than withdrawal (foreign or domestic)
POS transaction fee (foreign or domestic)
MOTO transaction fee
Paper or Offline transaction fee
Internet based transaction fee

### 2) Issuance Fees

Card issuance
Activation
Production
Fulfillment
Delivery
Background check
Credit check
Approval
CIP
KYR
BSA
AML
OFAC
Documentation review
   3) Periodic Fees, including periodic card or account maintenance fee on a monthly, annual or other periodic basis.
   4) Inactivity Fees, including a card or account inactivity fee and the definitions of a card or account inactivity fee.

### 5) Interchange Fees

6) Account Holder and/or Employer/Payor Fund Load fees via the following methods:
Check
Cash
ATM
ACH
Wire
Batch Transfer
Online Portal or Website
Money Transfer Agent
Check Cashing Agent
Money Order

### 7) Extension of Credit Fees

### 8) Interest Rates

9) NSF Fees, including insufficient funds (NSF) or overdraft

### 10) Card Replacement Fees

### 11) Account Closure Fees

### 12) Balance Reimbursement Fees

### 13) Bill Payment Fees

14) Fund Transfer Fees, by an Account-Holder and/or an Employer/Payor, including transfers via the following methods:
Account to account
Card to card
Card to account
Account to card
Within a financial institution
Outside a financial institution
Within a geographical boundary
Outside a geographical boundary

### 15) Currency Exchange Fees

### 16) Program Violation Fees

### 17) Participant Defined Custom Fee

Revenue Sharing

### 1) Advertising Revenues

### 2) Promotional Product Revenues

### 3) Third-Party Commissioned Sale Revenues

Definition of Conditions

### 1) Grace Periods

### 2) Interest Rates

### 3) Rewards

### 4) Promotional Offers

Account and Transaction Limits

### 1) Credit Limits

### 2) Deposit

Minimum
Maximum

### 3) Transfers

Minimum
Maximum

### 4) Balance

Minimum
Maximum
   5) Number of Transactions, in a defined user period:
Minimum Transactions in a defined user period (such as day, number of days, week, number of weeks, month, number of months, year, number of years)
Maximum Transactions in a defined user period (such as day, number of days, week, number of weeks, month, number of months, year, number of years)
   6) Number of a Specific Transaction Type, in a defined user period:
Minimum number of a specific Transaction type in a defined user period (such as day, number of days, week, number of weeks, month, number of months, year, number of years)
Maximum number of a specific Transaction type in a defined user period (such as day, number of days, week, number of weeks, month, number of months, year, number of years)

Program or Transaction Conditions

### 1) Merchant

Categories
Specific merchants
Merchant interface types
Merchant geographic locations

### 2) BINs

Specific BINs
BIN ranges

### 3) Expiration Dates

Account
Card
Card

### 4) Currency

### 5) Card Types

By technology type:
   Magnetic Stripe
   Embossed
   IC chip via contact points (smart card)
   NFC, such as contactless, RFID, or NFC
   Mobile Wireless Device
Specific issuing association
Category of issuing associations

### 6) Account Types

Credit card account
Debit card account
Prepaid card account
DDA or current account
Savings account
Online wallet account
Online portal account
Other defined and distinguishable account type

### 7) Customers, Clients, Payees, Payors

Specific individual or entity
Geographic location of individual or entity
Geographic residence of individual or entity

### 8) Financial Institutions

Category of Issuing Financial Institution
Specific Issuing Financial Institution
Specific Acquiring Financial Institution
Geographic Location of Financial Institution

### 9) Time of Day

Standard time
Time at cardholder's residence
Time at place of transaction
Time at issuer's address

### 10) Location of a Transaction

Geographic location of a transaction
Specific IP address of a participant
Category of IP address of a participant

### 11) Routing of a Transaction

Specific web browser of a participant
Category of web browsers of a participant
Specific network
Category of network
Specific electronic shopping cart
Category of electronic shopping carts

### 12) Other User Defined Custom Logic Function

### 13) Frequency of Application of Rule

Real-Time
Daily
Each Business Day
Monthly
Weekly (select day)
Monthly
   First day of the month
   Last day of the month
   Select day of the month (1-31)

### 14) Frequency of Distribution of Funds to Participants

Real-Time
Daily
Each Business Day
Monthly
Weekly (select day)
Monthly
   First day of the month
   Last day of the month
   Select day of the month (1-31)

### 15) Variable Determination Conditions

Equal to
Greater than
Less than
Greater than or equal to
Less than or equal to
Not equal to

### 16) Recipient Distribution Classifications

Processor [select % or $ for distribution]
Bank [select % or $ for distribution]
Network(s) [select % or $ for distribution]
Association(s) [select % or $ for distribution]
Merchant(s) [select % or $ for distribution]
Cardholder(s) [select % or $ for distribution]
Program Manager(s) [select % or $ for distribution]
Program Sub-Manager(s) [select % or $ for distribution]
   All Cards in Program [select % or $ for distribution]
   All Cards in Defined Group(s) [select % or $ for distribution]

Rewards could be awarded based on:
Number of friends referred into the program
Amount of spending of those friends
Number of transactions initiated by those friends
Referrals
Usage—dollar volume—in the aggregate or “pool” concept
Usage—number of transactions
Usage—at a particular merchant, during a particular time frame, or with other transaction-specific characteristics

With reference to FIG. 2, the sequence and flow of a typical electronic transaction can be illustrated. A request to initiate an electronic transaction can generally occur via a cardholder acting through a device 214 such as an ATM machine, POS machine, cell phone or computer terminal. An electronic message, for example in ISO 8583 standard message format, is electronically transmitted from device 214 through a network system 216 such as those operated by VISA, MasterCard or the STAR associations to the Transaction Processing Module 202, which typically would be operated by an Issuing Bank or service entity operating on behalf of an Issuing Bank. Transaction Processing Module 202 generally provides transaction request management services, including the step of parsing the received transaction request message into its constituent portions, including data portions such as card number, PIN number, merchant identification, merchant location, transaction type, transaction value, device identification, etc. Transaction Processing Module 202 may also perform the step of Account Verification/Validation by accessing Master Database 204 to determine that the transaction is one for which Transaction Processing Module 202 has authority. Upon verification and validation of the requested transaction, Transaction Processing Module 202 typically writes the parsed data portions of the transaction request message into an appropriate location in Master Database 204, and then communicates a message to Decision Module 220 that includes a pointer to the location of the now-stored data portions of the transaction request message. Transaction Processing Module 202 typically will run on a computer system that is located behind the security firewall of the operating entity for enhance the security of its activities and to better protect the integrity of network system 216.

Decision Module 220 functions in the system to determine in real time whether a requested transaction should be approved, and what fees and/or rewards are to be associated with the requested transaction. In response to the pointer for a particular requested transaction received from the Transaction Processing Module 202, Decision Module 220 utilizes business logic in the form of a rules engine to analyze all relevant attributes of the requested transaction in relation to all rules that are stored in the Master Database 204 that might be applicable to such requested transaction. Major portions of Decision Module 220 typically will run on a computer system that is located behind the security firewall of the operating entity for enhance the security of its activities and to better protect the integrity of Transaction Processing Module 202 and network system 216.

Rules typically exist in Master Database 204 relating to whether a requested transaction should be approved or disapproved, as well as whether a requested transaction should generate fees and/or rewards to one or more participants to the transaction. Rules stored in data tables in Master Database 204 may have associated with them one or more conditions, each with one or more condition values, as well as timing parameters defining when they are applicable and notification requests if one or more participants are to be notified in response to the passing or failing of a particular rule.

As discussed above, multiple participants in any requested transaction may be empowered to input information into Master Database 204 relating to any particular rule, condition, condition value, timing parameter, notification request, fee and/or reward that is relevant to a requested transaction. In a preferred embodiment, Master Database 204 includes access control lists and/or data tables associated with individual or groups of rules, conditions, condition values, fees and rewards, to maintain a structured and hierarchical relationship between potentially multiple entries from multiple participants. Level codes in an access control list or data table may be assigned to each participant that is authorized to enter inputs to each particular rule, condition, condition value, timing parameter, notification request, fee and/or reward (or relevant group thereof), to define and store in the Master Database 204 the hierarchy of permissions and authorizations that apply to such attribute, among the relevant participants. An access control list or data table for a particular rule could, for example, reflect that the Issuing Bank has the highest authorization or permission level, that a program manager is also authorized to make entries that might impact the application of that rule, but at a next lower level of permission, and that a cardholder is also authorized to make entries that might impact the application of that rule, but at the lowest level of permission.

In response to receipt of the pointer for a particular requested transaction received from the Transaction Processing Module 202, Decision Module 220 would access the identified location for the parsed transaction request message in Master Database 204, and retrieve from Master Database 204 each rule that is relevant to the approval or disapproval of the requested transaction. For each applicable rule, Decision Module 220 retrieves each applicable condition, and for each condition, each applicable condition value, each as input from one or more participants to the requested transaction.

In a preferred embodiment of the invention, rule checking logic within Decision Module 220 would operate to validate that the entries by the various participants to a particular rule or condition were consistent with the permission levels defined for each such participant. As discussed below, preferably this rule checking sequence is performed by Decision Module 220 at two distinct stages in the operation of the system; once at the time at which any addition or modification to a rule, condition, condition value, etc. is being made by any participant, and again each time a requested transaction triggers the retrieval and application of such rule, condition, condition value, etc.

By way of example, Decision Module 220 might determine by accessing Master Database 204 that a first data portion of a parsed transaction request message relates to the transaction amount, and that the transaction amount is subject to a rule that prohibits cumulative transaction amounts beyond a defined level within a prescribed period of time. Such a rule might have multiple conditions associated with it; e.g., the cumulative amount and the time period. Multiple participants in the requested transaction might have input multiple condition values associated with each of the multiple conditions associated with the rule. For example, an Issuing Bank might have first entered the rule and further input an amount of $1000 and 48 hours as condition values applicable to the two conditions. A program manager (with a lower level authorization code in the access control list) might in turn have input an amount of $750 for a maximum amount, and a cardholder (with the lowest level authorization code in the access control list) might have further input 24 hours as the applicable time condition.

Decision Module 220 would retrieve all of the relevant conditions and condition values associated with a particular applicable rule and the level codes associated with each of the potentially multiple condition values. Business logic associated with the rules engine would then apply the condition values in accordance with the authorization level codes associated with each to determine the appropriate conditions for the rule, and thereafter retrieve all necessary data from Master Database 204 to enable its proper application to the data portion of the requested transaction. For example, the rules engine would determine that the applicable conditions for the proper application of the rule identified in the example above was that the requested transaction was to be approved only if the cumulative amount of recent transactions did not exceed $750 in the prior 24 hours.

Of course, numerous distinct rules within Master Database 204 might require retrieval, analysis and a positive conclusion for any particular requested transaction before a final approval decision might be reachable by the Decision Module 220.

Typically, in one preferred embodiment of the invention, the Decision Module 220 determines in virtual real time the fees that are applicable to a requested transaction, after making its determination concerning the approval or disapproval of the requested transaction, inasmuch as the determination concerning approval or disapproval may have an impact upon the fee determination. As with the process for determining approval or disapproval, the fee determination process entails the retrieval by the Decision Module 220 of each rule in the Master Database 204 that pertains to the fee determinations, and the associated conditions, condition values and level codes associated thereto. Business logic associated with the rules engine would then apply the condition values in accordance with the authorization level codes associated with each to determine the appropriate conditions for the rule, and thereafter retrieve all necessary data from Master Database 204 to enable the proper fee determination for the requested transaction.

Typically, the Decision Module 220 determines rewards associated with the requested transaction in like fashion.

Upon completion of the approval, fee and reward determinations for a requested transaction, Decision Module 220 inputs and/or modifies appropriate data into the records of the Master Database 204 and formulates response codes that reflect its determinations for the requested transaction for transmission back to the Transaction Processing Module 202 and all of the appropriate participants to the transaction. In one embodiment of the invention this may be accomplished via an XML message from Decision Module 220 to Transaction Processing Module 202.

Also shown in FIG. 2 is a Batch Processing Module 208, which is employed to perform processes related to a requested transaction that need not occur in real time. For example, at the end of a given business day, Batch Processing Module 208 can be activated to perform reconciliation, settlement of accounts among banks, interchange processing and automated clearinghouse transactions (ACH).

Decision Module 220 is also able to communicate electronically selected results of its determinations associated with a requested transaction to the Program Manager Portal 222 and/or to the Cardholder Portal 224. Program Manager Portal 222 and Cardholder Portal 224 may be located inside or outside the security firewall. Program Manager Portal 222 provides a convenient and structured interface for communications between the Decision Module 220 and institutional participants such as Issuing Banks, Acquiring Banks, associations such as VISA, MasterCard and STAR, and program managers and sub-program managers. Cardholder Portal 224 provides a convenient and structured interface for communications between the Decision Module 220 and cardholders.

Participants are able to input notification requests into Master Database 204 that automatically provide notifications to identified participants in the event that Decision Module 220 makes a particular determination in response to processing a rule or condition. For example, a rule associated with the approval decision by the Decision Module 220 might be conditioned upon whether the card had been reported stolen within a recent defined time period. If Decision Module 220 disapproves a requested transaction on this basis, an action can also be triggered by a rule that directs that the Program Manager Portal 222 and/or the Cardholder Portal 224 supply an electronic alert that a card previously reported as stolen has been used at a particular Device 214.

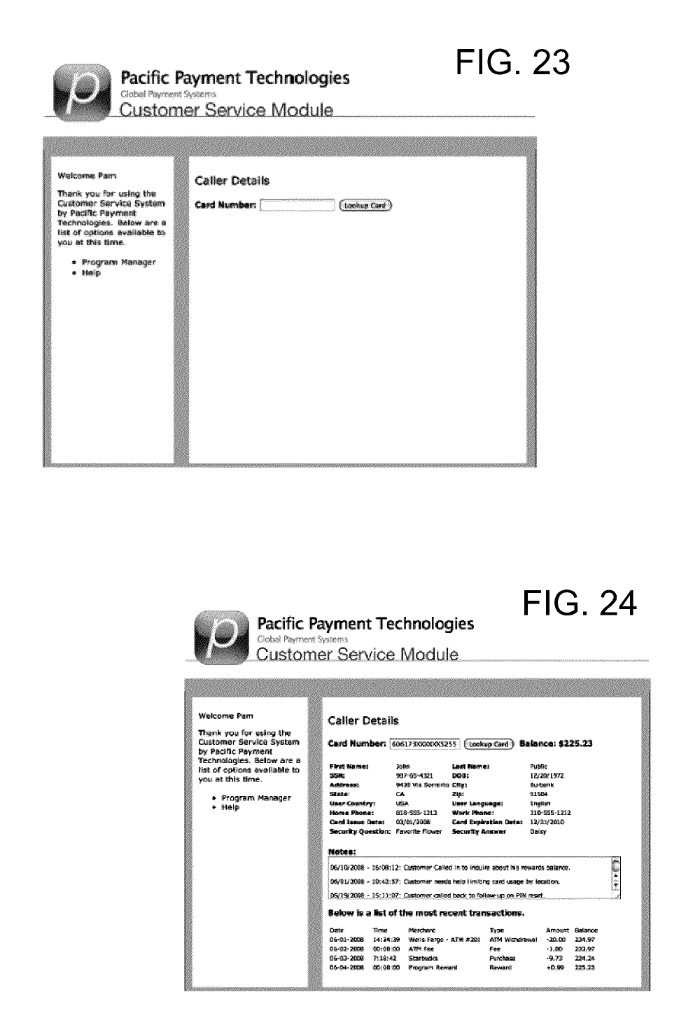

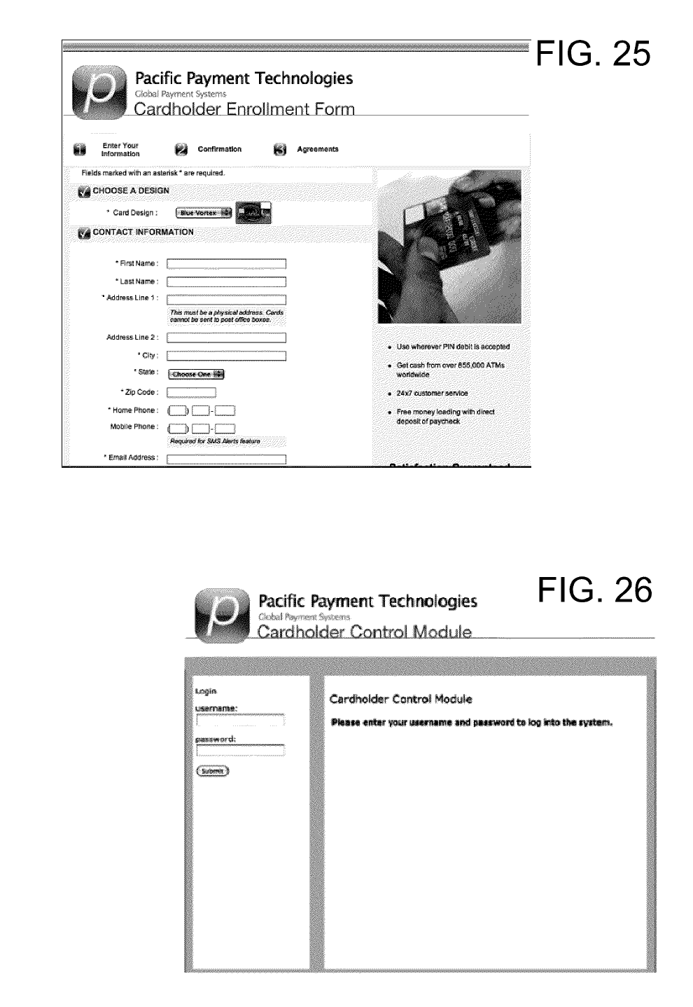

Program Manager Portal 222 and/or the Cardholder Portal 224 may also be utilized by participants to requested transactions to access authorized portions of Master Database 204 via Decision Module 220, for example to determine account balances and to input rules, conditions, condition values, fee and rewards into the system. In particular, Program Manager Portal 222 can be securely made available to a variety of different institutional participants such as Issuing Banks, Receiving Banks, Associations, Program Managers and Sub-Program Managers to enable access to the program management module as shown in FIGS. 3-22 and the customer service module as shown in FIGS. 23-25. Similarly, Cardholder Portal 224 can be securely made available to cardholders to enable access to the cardholder module as shown in FIGS. 26-49.

Embodiments of the invention effectively provide for the varying interests and concerns of multiple participants to an electronic transaction, and apply such interests and concerns in accordance with an established hierarchical relationship between the participants, on a topic-by-topic basis. For example, an issuing bank, acquiring bank or other financial institution might want to limit the total dollar amount of cash withdrawn at an ATM in a 24-hour period for purposes of limiting exposure to fraudulent card usage. A cardholder might want to further limit that dollar amount he or she might withdraw from an ATM as a fraud-management tool or as a mechanism for controlling his or her access to his or her funds (a self-disciplinary tool).

Typically the financial institution might want to set broad limitations. A program management company might want to narrow those limitations somewhat. A cardholder might want to narrow those limitations even further. In such an example, the hierarchical relationship would typically be established with the financial institution at a relatively higher level, program manager at an intermediate level, and cardholder at a relatively low level. Business logic of the decision module 220 would effectively retrieve the condition values inputted by each of the interested participants, apply them according to their hierarchical relationship, and make decisions concerning the requested transaction accordingly.

Prior to authorizing or denying a transaction, a transaction message is passed to the decision module 220 where it is analyzed using the data input from the various participants to the transaction. Through the application of the rules, condition values, fees and reward entries in the database 204, as constituted at the moment of analysis, a timely, intelligent and dynamic determination can be returned to the transaction processing system 202 from decision module 220 for communication back to the participants requesting and involved in a requested transaction.

Although transaction processing systems previously defined and applied rules relative the handling of transactions, those rules were both static and mandated by or through a single participant in the transaction. The decision module 118 provides an essential mechanism for incorporating the preferences of all participants into a dynamic and responsive system.

Participants are able to view, access and interact through their interface to the decision module 220. Through the addition, modification, and deletion of rules, conditions, condition values, timing parameters, notification requests, fees and rewards, via this interface, the participant has additional control and flexibility with respect to the management of their electronic economic transactions that operate through the system.

The decision module 220 may communicate with participants to an economic transaction via secured and encrypted Internet connections, telephonically via a TCP/IP protocol or through directly networked servers. Through the addition, modification, and deletion of rules, conditions, condition values, timing parameters, notification requests, fees and rewards, via a standard or custom interface, the participant will have additional control and flexibility with respect to the management of their electronic economic transactions that operate through the given system.

Using consumer interface 121 in FIG. 1 or Cardholder Portal 224 as shown in FIG. 2, a consumer or cardholder is able to enter his or her preferences with respect to the management of their financial account, card and/or device in the intercourse of electronic economic transactions. Input received from this participant is dynamically presented for validation against any and all incoming transactions relative to this participant, thereby providing a high level of control, flexibility and security in managing their interactions with other participants to a transaction.

Currently, consumers or cardholders initiate a transaction, but may be unaware of system mandated conditions, or the actual identity of the merchant. Through the application of the decision module 220, the consumer is given the ability to distinguish through rules and conditions, their preference to consummate the transaction, once the variables are presented through the system.

From the consumer perspective, a primary application of the device is to deter theft and fraud by setting rules that would preclude transactions from being consummated that are outside self-established boundaries.

Decision Module 220 also can interface directly with a merchant. Using merchant interface 122 in FIG. 1 or Program Manager Portal as shown in FIG. 2, a merchant is able to enter its preferences with respect to the management of their financial account, card and/or device in the course of electronic economic transactions. Input received from the merchant is dynamically presented for validation against any and all incoming requested transactions involving this merchant, thereby providing the merchant with a high level of control, flexibility and security in managing their interactions with other participants to a requested transaction.

Currently, merchants are often not able to distinguish between customers due to the somewhat anonymous nature of electronic transactions. As one of many possible examples, merchant may need to comply with governmental policies that may prohibit transactions occurring from or within a particular country or jurisdiction, and with a dynamic rules engine, these types of policies can be more easily and efficiently administered.

Decision Module 220 also can interface directly with a card issuing financial institution. Using merchant interface 122 in FIG. 1 or Program Manager Portal as shown in FIG. 2, a card issuing financial institution is able to enter its preferences with respect to the management of their financial account, card and/or device in the course of electronic transactions. Input received from the issuer can be dynamically presented for validation against any and all incoming requested transactions involving this participant, thereby providing a high level of control, flexibility and security in managing their interactions with other participants to a transaction.

Although issuer financial institutions play a significant role in establishing policy that is coded into processing systems currently, it is often difficult for them to make modifications on a timely basis, or use advanced logic in creating rules. Decision module 220 provides these capabilities to issuer financial institutions.

Acquiring financial institutions can also enter their preferences with respect to the management of their financial account, card and/or device in the intercourse of electronic economic transactions. Input received from this participant is dynamically presented for validation against any and all incoming transactions relative to this participant, thereby providing a high level of control, flexibility and security in managing their interactions with other participants to a transaction.

Although acquirer financial institutions play a significant role in establishing policy that is coded into processing systems currently, it is often difficult for them to make modifications on a timely basis, or use advanced logic in creating rules. Decision module 220 provides these capabilities to acquirer financial institutions.

The network, or networks, can also enter their preferences with respect to the management of their financial account, card and/or device in the intercourse of electronic economic transactions. Input received from this participant is dynamically presented for validation against any and all incoming transactions relative to this participant, thereby providing a high level of control, flexibility and security in managing their interactions with other participants to a transaction.

Banking association networks may program their rules into their own networks, such that any logic applied may preclude the transaction from being forwarded to a transaction processor for further determinations. In some, if not many cases a network may prefer to interact with a dynamic and soft-coded rules engine rather than making modifications to a proven coded system. This may be true from both an operational (processing time) basis and a cost basis.

An association can also enter their preferences with respect to the management of their financial account, card and/or device in the intercourse of electronic economic transactions. Input received from this participant is dynamically presented for validation against any and all incoming transactions relative to this participant, thereby providing a high level of control, flexibility and security in managing their interactions with other participants to a transaction.

Associations (such as Visa, MasterCard and STAR) currently dictate a first level of transaction policy and expect the other participants of the transaction to implement the policy. This is perhaps largely due to the limitations of technology heretofore. With decision module 220, associations could input policy determinations and have them take effect on a limited basis or extended basis at will.

The program manager (ISO, MSP, or other designated program agent) can also enter their preferences with respect to the management of their financial account, card and/or device in the intercourse of electronic economic transactions. Input received from this participant is dynamically presented for validation against any and all incoming transactions relative to this participant, thereby providing a high level of control, flexibility and security in managing their interactions with other participants to a transaction.

Although program managers play a role in establishing policy that is coded into processing systems currently, it is often difficult for them to make modifications on a timely basis, or use advanced logic in creating rules. It is also very costly, in many cases for them to modify rules and fees. Decision module 220 provides these capabilities to program managers.

Likewise, sub-program managers can also enter their preferences with respect to the management of their financial account, card and/or device in the intercourse of electronic economic transactions. Input received from this participant is dynamically presented for validation against any and all incoming transactions relative to this participant, thereby providing a high level of control, flexibility and security in managing their interactions with other participants to a transaction.

Although sub-program managers play a role in establishing policy that is coded into processing systems currently, it is often difficult for them to make modifications on a timely basis, or use advanced logic in creating rules. It is also very costly, in many cases for them to modify rules and fees. Decision module 220 provides these capabilities to sub-program managers.

Electronic shopping cart or virtual POS operators can also enter their preferences with respect to the management of their financial account, card and/or device in the intercourse of electronic transactions. Input received from this participant is dynamically presented for validation against any and all incoming transactions relative to this participant, thereby providing a high level of control, flexibility and security in managing their interactions with other participants to a transaction.

The decision module 220 preferably supports a web-based host for interfacing with multiple participants to electronic economic transactions. For example, in one embodiment, a web-based portal is provided that includes three related sub-modules; a program management module as shown in FIGS. 3-21, a customer service module as shown in FIGS. 22-24, and a cardholder control module as shown in FIGS. 25-48.

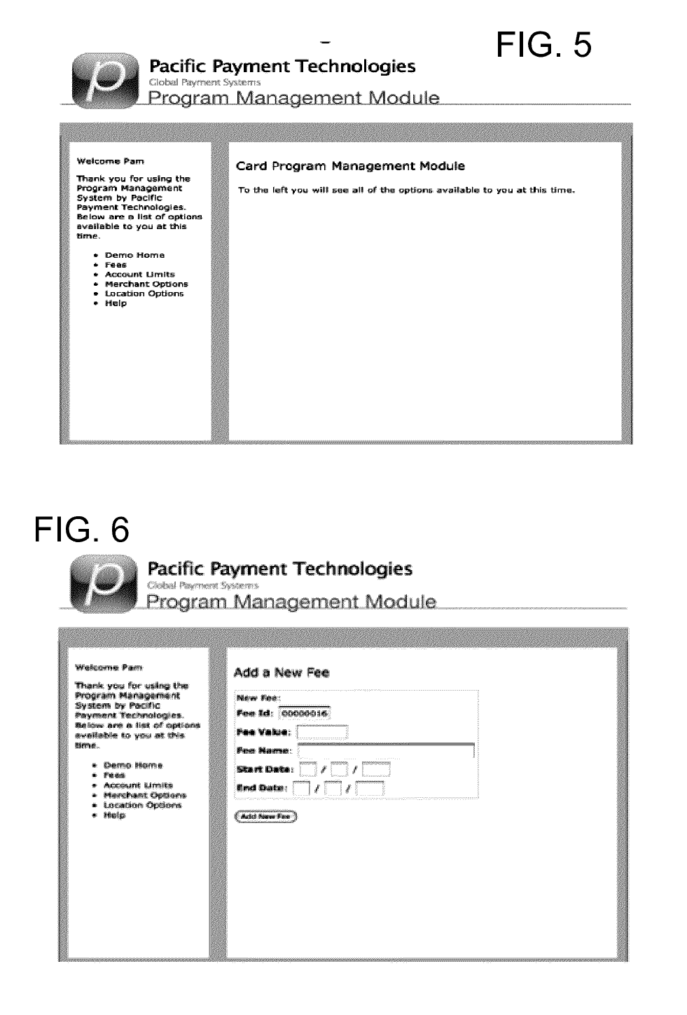

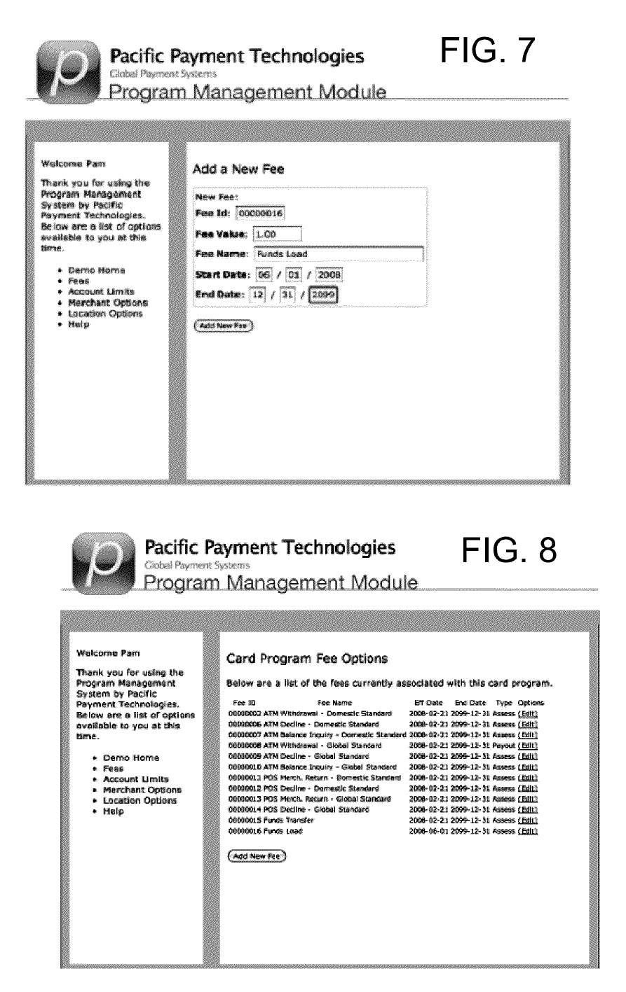

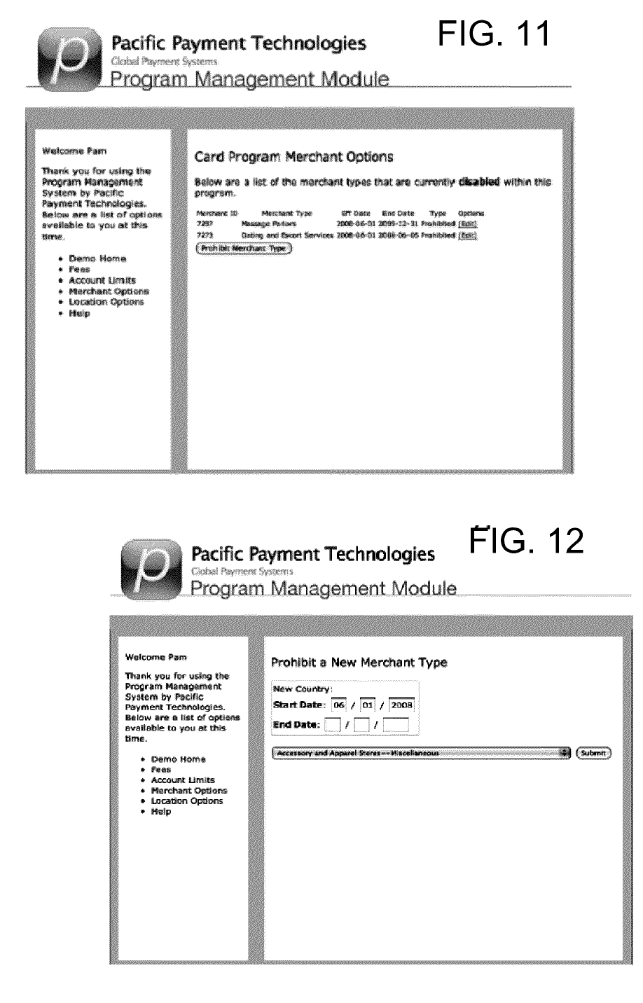

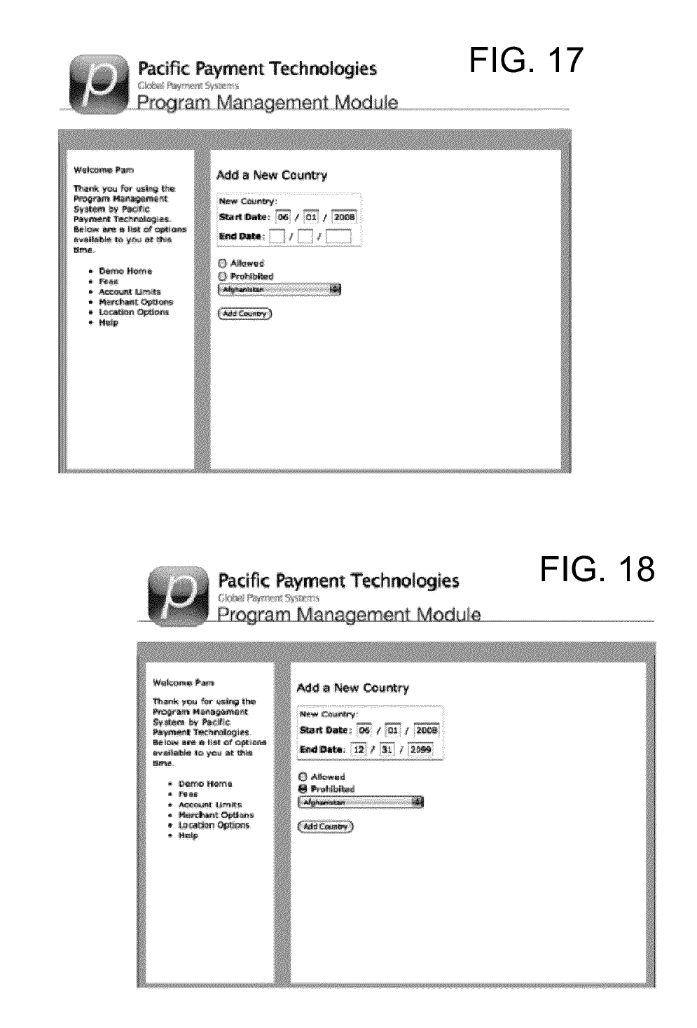

Program Management Module may be presented to institutional participants via Program Management Portal 222 (in FIG. 2) and is intended for use by program managers, including issuing banks, receiving banks, associations and sub-program managers, and enables a creator or manager of a card program to perform such functions as input or altering of rules, conditions and condition values relating to fees, rewards, account limits, merchant options, and/or location options. For example, as shown in FIG. 5, a user of the program management module may manage one more card programs, generate management reports relating to one or more card programs and/or accounts included within such card programs, and operate a Customer Service function to respond efficiently to request of cardholders participating in and of such card programs. Numerous management functions are enabled through a participant's use of the program management module, including adding fees to a card program (FIGS. 7-10), inputting or modifying card load and/or withdrawal limits (FIG. 11), adding or prohibiting certain merchant types (FIGS. 12-16), and managing locations associated with a card program (FIGS. 17-21). Card Program Reports can also be efficiently generated and displayed, including examples such as Card Issue Reports, Card Usage Reports, Load and Trans Reports and Fee and Interchange Reports (FIG. 22).

Customer service module as shown in FIGS. 22-24 may be presented to institutional participants via Program Management Portal 222 (in FIG. 2) and is intended for use by program managers and sub-program managers and enables a creator or manager of a card program to provide effective online customer service to cardholders, including for example providing balance information and recent transaction information in response to customer inquiries (FIGS. 22-24).

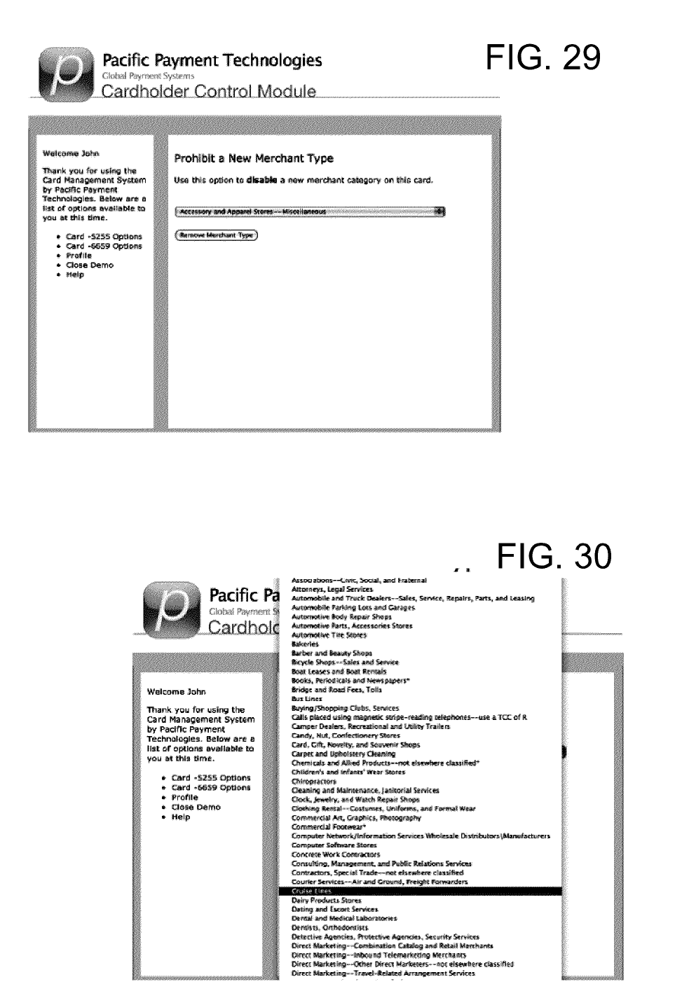

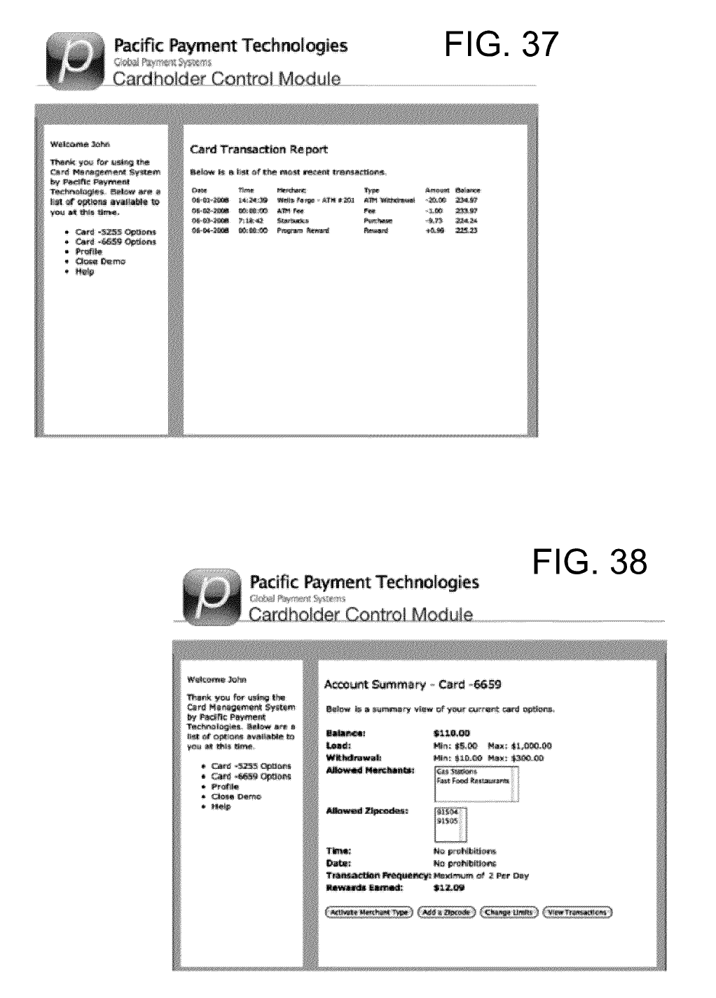

The Cardholder Control Module (shown in FIGS. 25-48) may be presented to institutional participants via Cardholder Portal 224 (in FIG. 2) and is intended for use by cardholders, and enables a cardholder to perform such functions as accessing account information and program limits (FIG. 29), transaction information, and input or altering of rules, conditions and condition values relating to approving or prohibiting electronic transactions with for example, particular merchants, merchant types (FIGS. 30-33), geographic locations (FIGS. 34-36), fund loading limits (FIG. 37), withdrawal limits, transaction limits, etc.

As discussed above, multiple participants can use the Program Management Portal 222 and/or Cardholder Portal 224 to input information concerning the same rule, condition and/or condition value. The Decision Module 220 will approve or disapprove of a particular requested transaction in accordance with such rules, conditions and condition values, in further accordance with business logic and the level codes associated with each participant and attribute reflected in access control lists maintained in the Master Database 204. In this manner a hierarchical relationship between and among rules, conditions and condition values can be efficiently maintained and implemented, in response to each requested transaction received and processed by Decision Module 220.

Program Management Portal 222 may include in one embodiment of the invention a Rule Management Module as shown in illustrative screen displays in FIGS. 49-64. A similar but possibly less extensive Rule Management Module would also be included in and presented to cardholders via the Cardholder Portal 224.

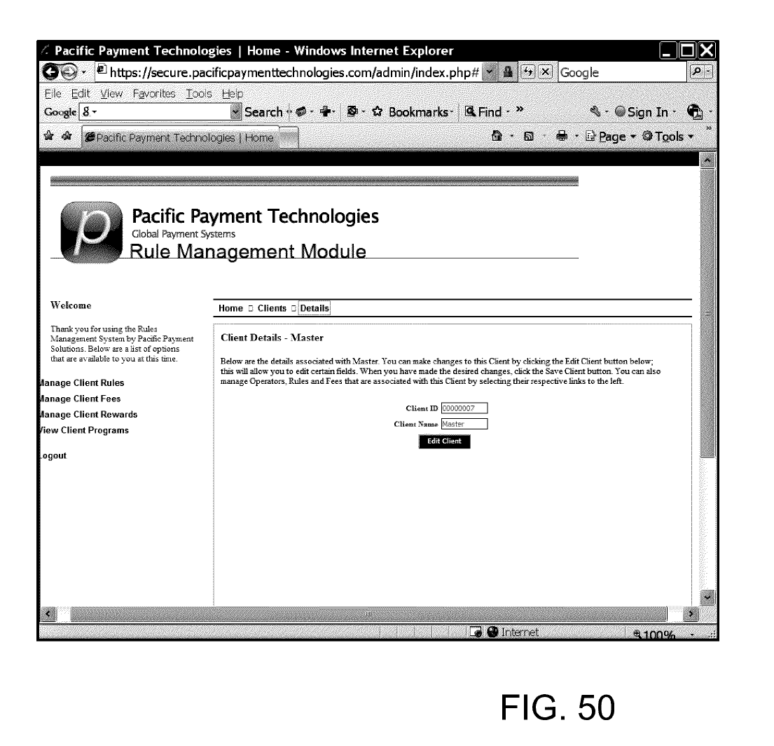

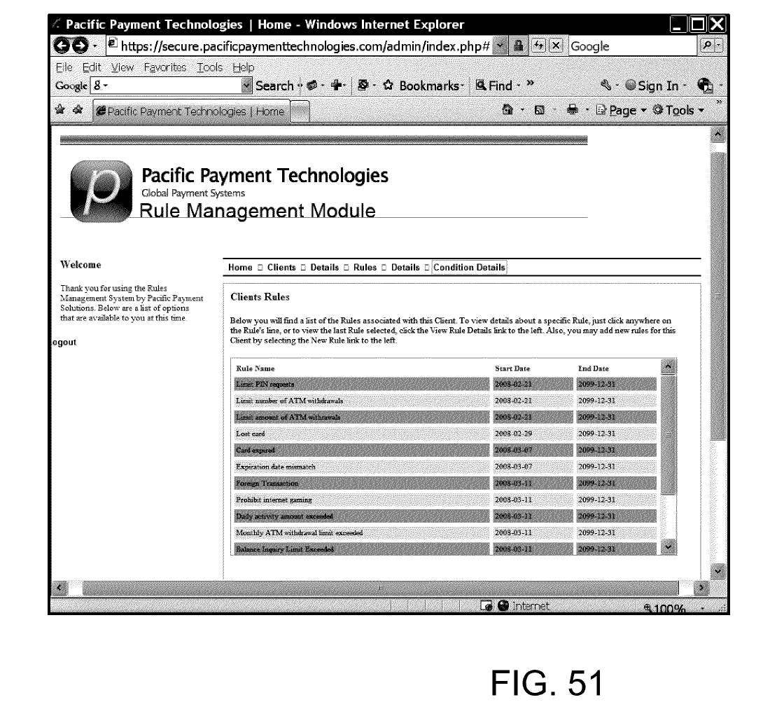

Rule Management Module enables a participant to conveniently input and/or modify rules, fees, rewards and associated conditions, condition values, timing parameters and notification requests in the Master Database 204. FIG. 49 displays the introductory login screen associated with a Rule Management Module. FIG. 50 reflects some of the basic capabilities of the Rule Management Module, including the ability for a participant to manage client rules, manage client fees, manage client Rewards and view different client card programs. FIG. 51 shows a list of exemplary client rules that have been inputted into the Master Database 204 for various requested transaction associated with a particular pre-paid card program. Rules can have associated with them timing parameters such as a start date and an end date, that are established by an authorized participant, thereby enhancing a participant's ability to develop, customize and refine cardholder programs.

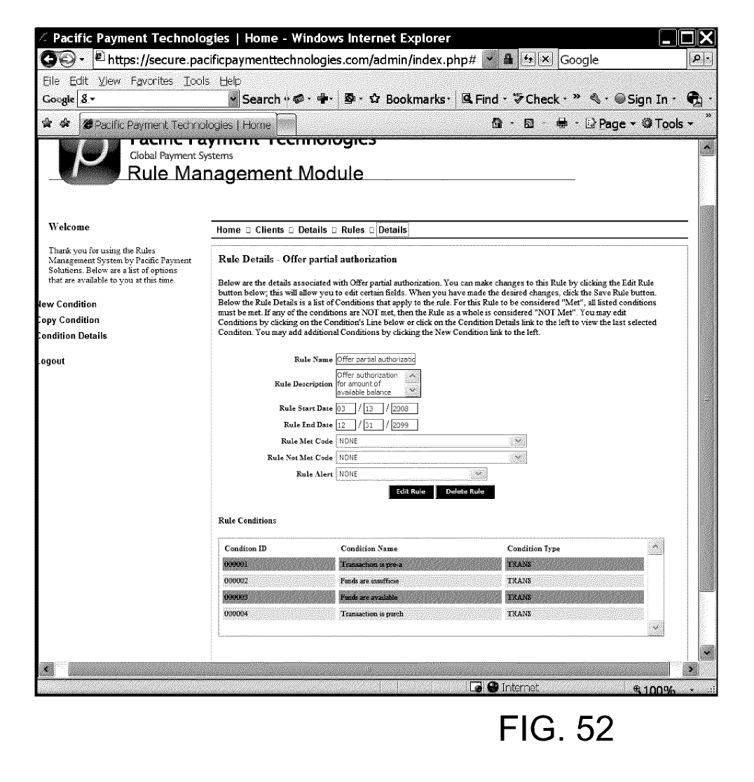

With reference to FIG. 52, rule details relating to one of the rules shown in FIG. 51 (“Offer Partial Authorization”) is displayed, as it would be presented to a participant interested in inputting and/or modifying such rule. Rules typically include a Rule Name, Rule Description, Rule Start Date, Rule End Date, Rule Met Code, Rule Not Met Code, Rule Alert field, and one or more Rule Conditions, all definable by an authorized participant inputting and/or modifying the rule. Rule Conditions have associated with them a Condition ID, a Condition Name, a Condition Type, and Condition Details discussed below.

As shown in the exemplary rule in FIG. 52, the rule entitled “Offer Partial Authorization” is described as being for the purpose of “Offer authorization for amount of available balance” and if the Rule is determined by the business logic of the decision module to be “met”, offers to authorize a requested transaction at a level below the requested amount and equal to the amount of the available balance in the account or card. An authorized participant can define the business logic associated with a rule. For example, as explained in the text portion of FIG. 52, the rule is defined to be “Met” when all associated Conditions have been logically determined to be “met,” and the rule is not met if any of the conditions are not met. The “Offer Partial Authorization” rule reflected in FIG. 52 has four conditions associated with it. In general, rules can have one or more conditions.

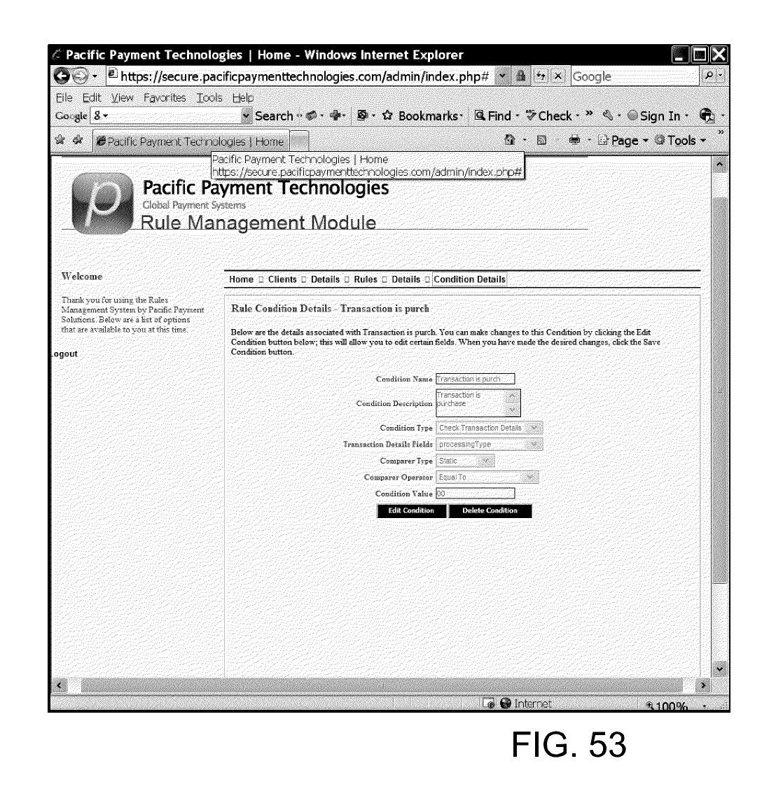

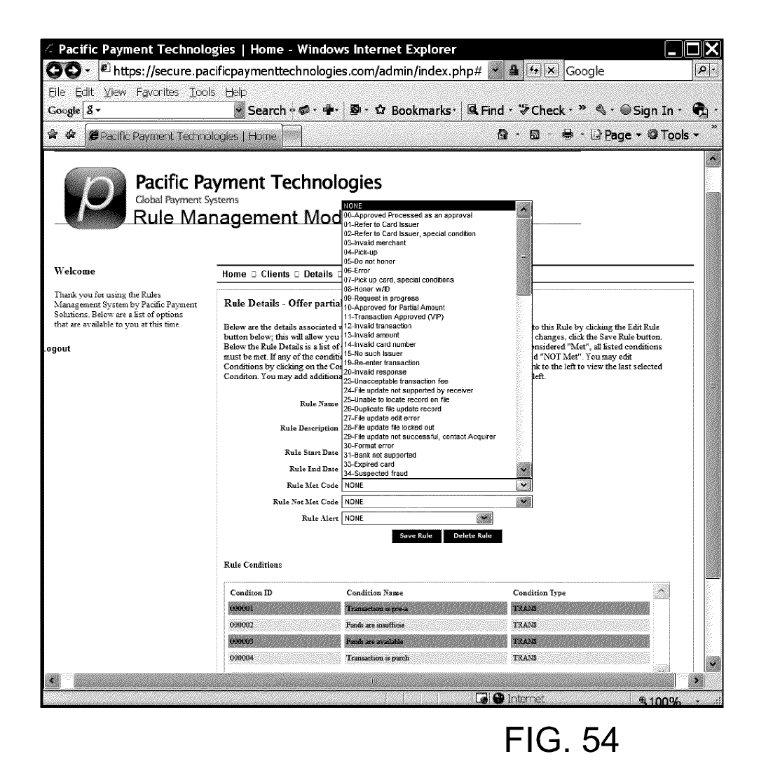

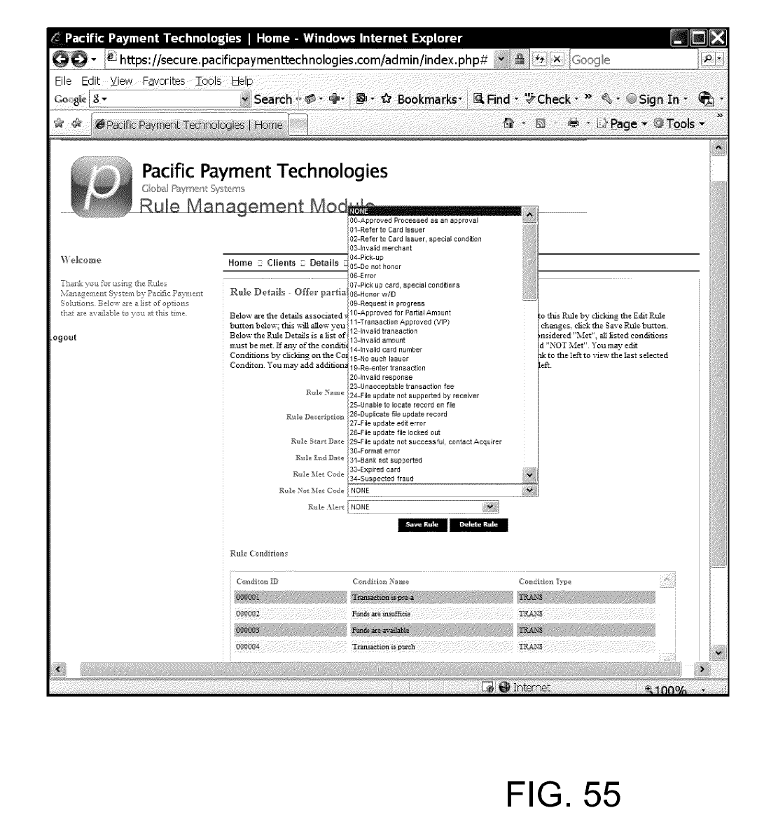

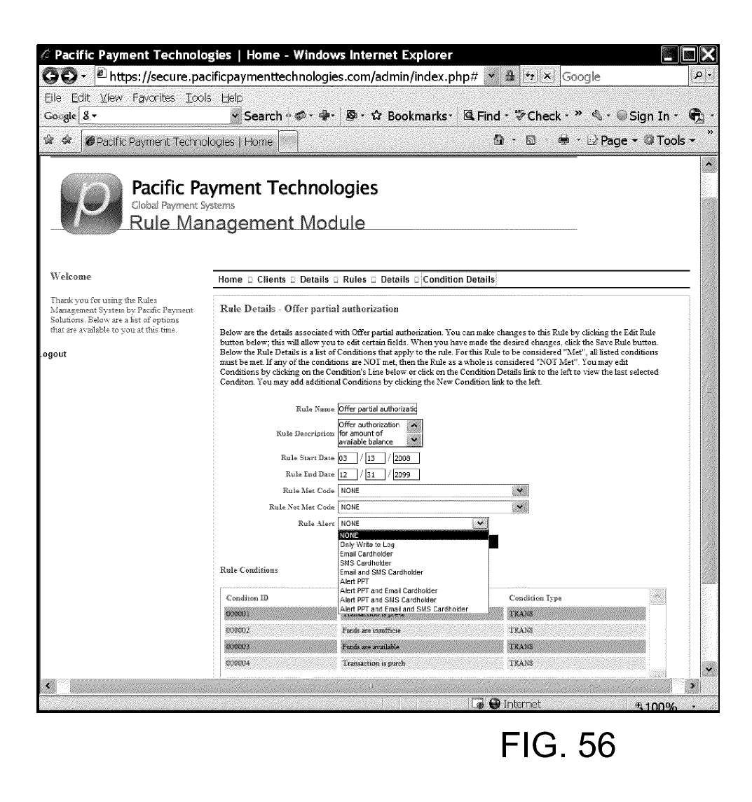

With reference to FIG. 53, the Rule Condition Details associated with the fourth of the conditions is form FIG. 52 is displayed, entitled “Transaction is a purchase.” Conditions typically include a Condition Name, a Condition Description, a Condition Type, Transaction Detail Fields, a Comparer Type, a Comparer Operator, and a Condition Value. Authorized participants are able to edit such condition details, typically by selecting among options presented on drop-down menus as shown in FIG. 54. FIG. 54 displays a list of “Rules Met Codes” that can be selected by a participant for transmission to the transaction processing system if the rule is determined to be satisfied. Similarly, FIG. 55 displays a list of “Rules Not Met Codes” that can be selected by a participant for transmission to the transaction processing system if the rule is determined to not be satisfied. FIG. 56 displays a list of exemplary Rule Alerts that can be selected by a participant if the rule is determined to not be satisfied.

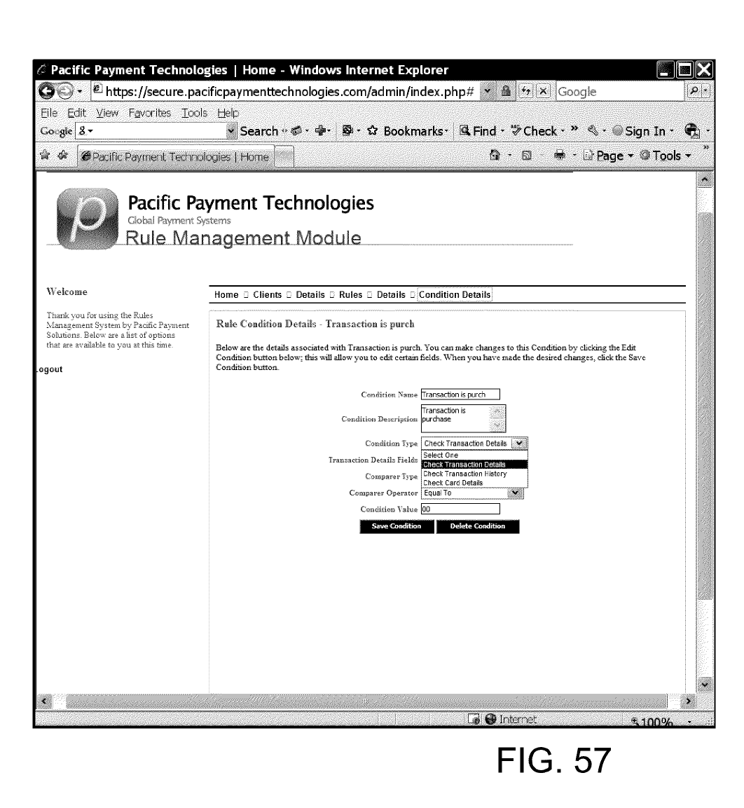

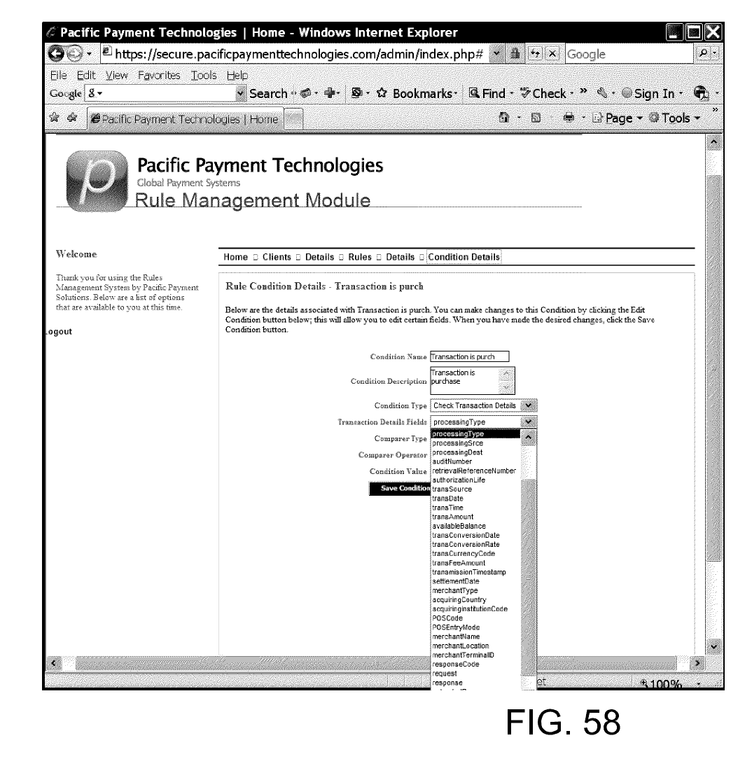

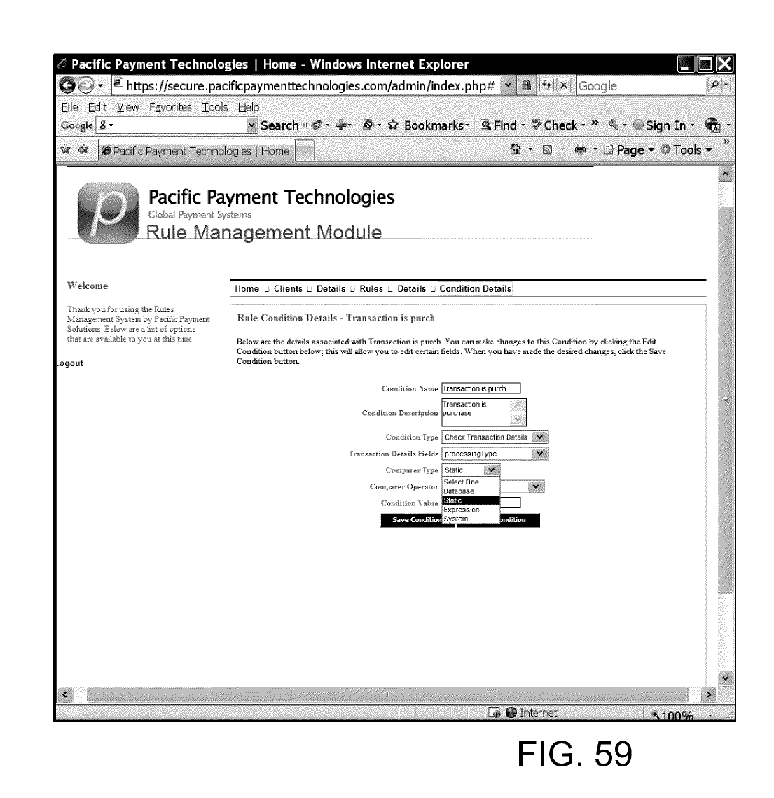

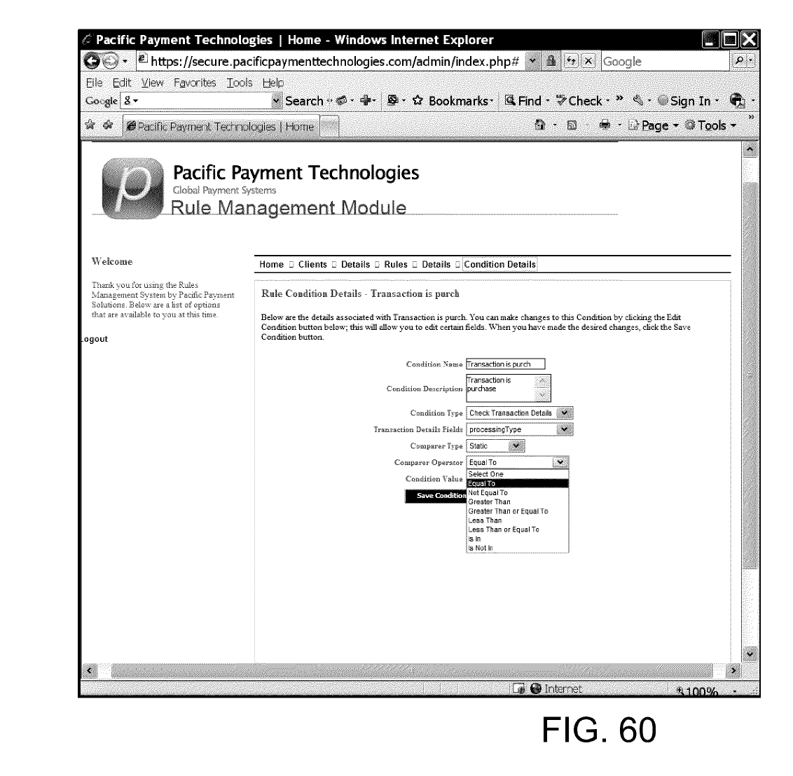

FIG. 57 displays the condition details associated with the fourth condition shown on FIGS. 52- 56 (Condition ID “000004”; Condition Name “Transaction is purch.”) Condition details may include a Condition Description, a Condition Type, Transaction Detail fields, Comparer Type, Comparator Operator, and Condition Value. As shown in FIG. 57, Condition Types can include Check Transaction Details, Check Transaction History and Check Card Details. As shown in FIG. 58, Transaction Detail Fields can include many possible entries that are selected by a participant. FIGS. 59 and 60 display exemplary entries that can be selected by a participant for the Comparer Type and Comparer Operator, respectively, the selection of which contributes to and helps define the business logic associated with the determination of whether a condition has been satisfied.

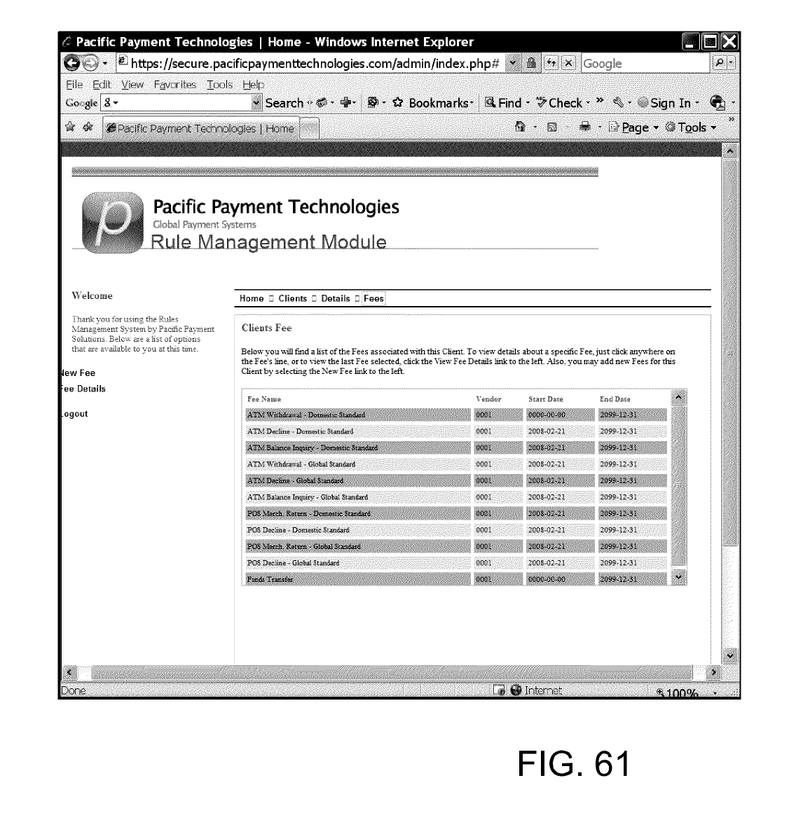

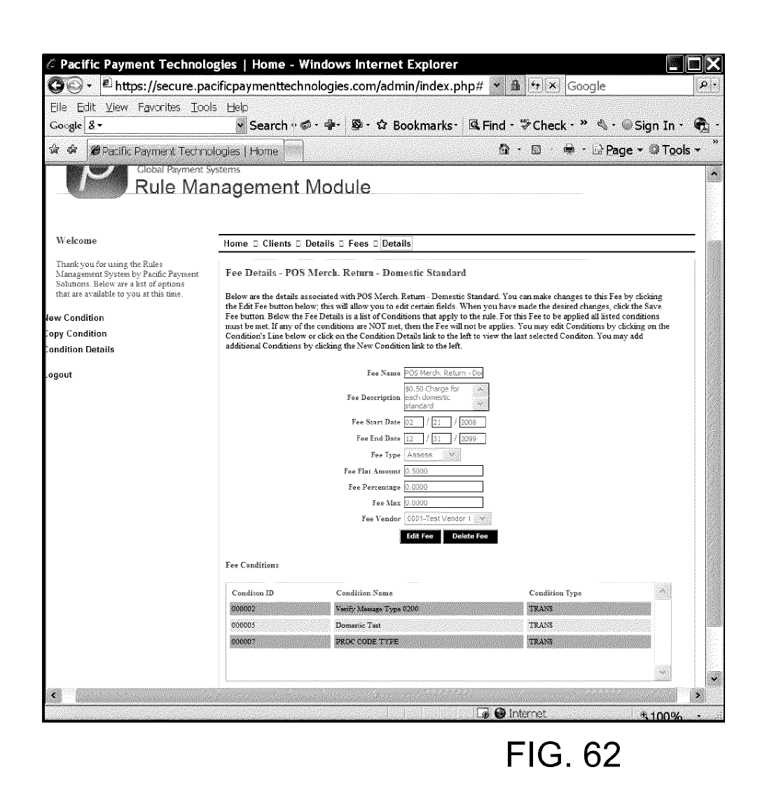

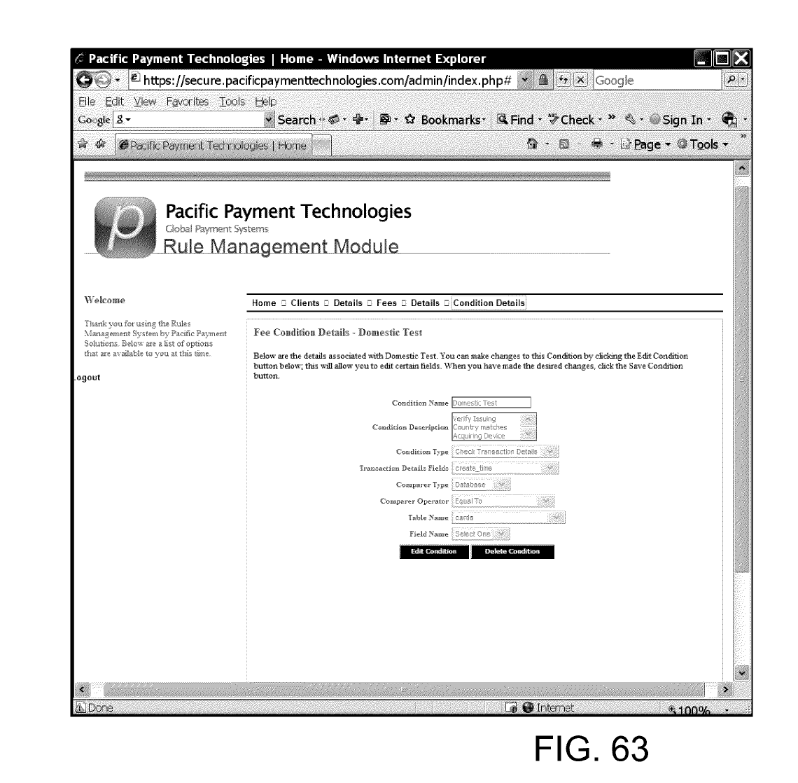

FIG. 61 illustrates the portion of the Rule Management Module that relates to a participant's ability to input and modify Fees associated with a particular requested transaction. As can be seen, a large variety of different Fee types can be instituted. FIGS. 62 and 63 display Fee Details associated with one of the Fees reflected in FIG. 61, along with the Fee Conditions Details that can be associated to Fees, in a manner similar to those discussed above that apply to Rules.

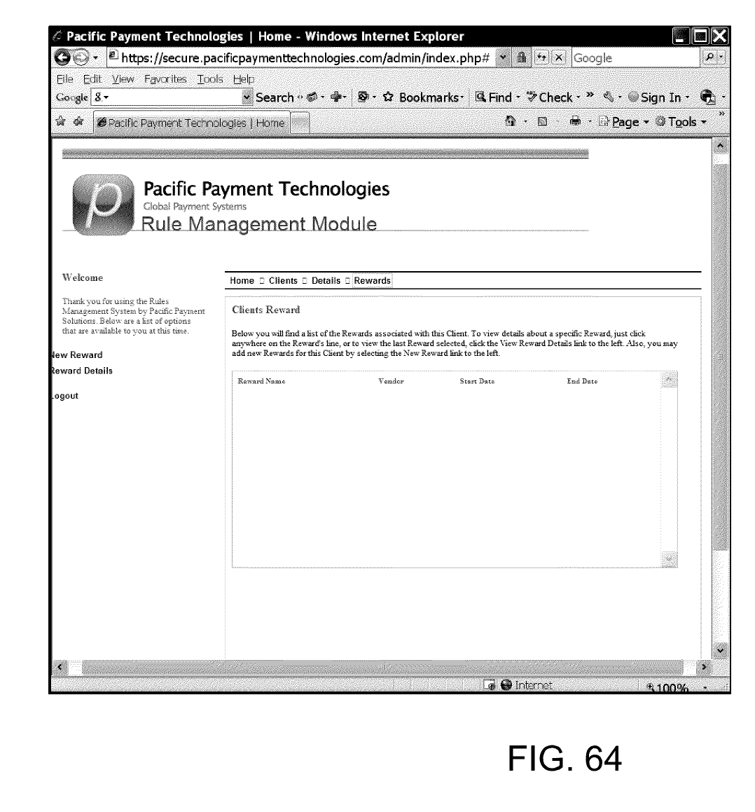

FIG. 64 illustrates the portion of the Rule Management Module that relates to a participant's ability to input and modify Rewards associated with a particular requested transaction. As with Rules and Fees, Rewards are more fully defined in terms of Reward Details, that in turn include Condition Details, all of which can be input or modified by authorized participants.

The business logic of the decision module preferably performs a rule-checking function at two separate stages during the operation of the system; once when rules, conditions and/or condition values are being inputted and/or modified by a participant, and again upon receipt by the decision module of each requested transaction. The former process is preferably implemented to validate the propriety of a change to any rule, condition or condition value, in view of the authorization or permission level of the acting participant relative to other participants who may have inputted or modified each associated rule, condition or condition value. As discussed briefly above, participants preferably have assigned to them a level code or similar designation that identifies their relative priority level in a hierarchy of participants defined within the system. As a simple example, for a particular rule, condition and/or condition value (or convenient grouping thereof), software developers responsible for creating the basic system might be allocated a level code of “1” to reflect unlimited and top-level rights to define rules, conditions and condition values. In this manner the system could be developed to include general rules that were mandatory parts of such a system, and or to establish certain commonly used rules that could be refined and customized by various participants. An Issuing Bank or a top-level Program Manager might be allocated a level code of “2” to reflect high-level authority to define a broad set of rules and conditions that it required be followed for transactions with which it was willing to be associated. A Sub-Program Manager might be allocated a level code of “3” to reflect mid-level authority to narrow or constrain further a broad set of rules and conditions that was established by the Program Manager. The cardholder might be allocated a level code of “4” to reflect the lowest level of authority, but still able to narrow or constrain further a set of rules and conditions that was established by the Sub-Program Manager. In concept, a parent/child relationship is established between a more highly empowered participant and a lower empowered participant such that the lower-empowered participant cannot override constraints upon requested transactions that are inputted by the more highly empowered participant.

The business logic of the decision module preferably performs a rule checking function at the stage of input and/or modification by any participant to confirm that a lower-level participant does not expand or enlarge the application or conditions associated with a rule inputted or modified by a higher-level participant. By way of simple example, if a “2”-level Program Manager had inputted a rule that if met, disapproved a requested transaction if more than $2000 had been previously withdrawn from the account within the previous 3 day period, a “3”-level sub-program manager might properly further constrict the associated conditions by entering a $1000 withdrawal limit, and a “4”-level cardholder might properly further constrict the associated conditions by entering a 1 day period. However, edits to expand the conditions associated with such rule would be checked and rejected by the rule checking function of the decision module, if attempted by a lower-leveled participant.

In response to receipt of a requested transaction, the business logic of the decision module retrieves all Rules associated with a requested transaction and applies the Rule Conditions associated with each Rule, in this example, two identified in the system as Condition IDs 000001 and 000002. As evidenced by the highlighted buttons of FIG. 51, a participant is empowered to either edit such rule or delete such rule. In a preferred embodiment, in response to receipt of a requested transaction, the business logic of the decision module checks the Rules associated with a requested transaction in an ordered fashion beginning with the inputs to the Rule entered by the highest level participant. If the Rule is not satisfied with respect to the highest level, no further processing is required because the Rule will have been determined to fail in its least restrictive form. If the Rule passes at the highest level, then each lower level is checked in turn until it is determined that the Rule has been satisfied in its most restrictive (lowest level) form.

With reference to FIG. 52, rule condition details relating to one of the conditions shown in FIG. 51 (“Condition ID 000001”) is displayed. Conditions have associated with them Condition Names, Condition Descriptions, Condition Types, Card Detail Fields, Comparer Types, Compared Operators and Condition Values, all of which are enterable or editable by an authorized participant. By inputting and/or modifying the entries for Condition Types, Card Detail Fields, Comparer Types, Compared Operators and Condition Values, the business logic associated with that Condition and the associated Rule may be conveniently established and/or altered by a participant.

The invention contributes dramatically to the flexibility and variability that can be realized in a card program. An Issuing Bank or Program Manager can create a card program with broadly defined rules and conditions that are applicable to a wide range of different applications, merchants and cardholders. Other institutional participants such as program managers and sub-program managers can more narrowly define rules, conditions and condition values to customize its application to a more specific group of cardholders and/or merchants, and conveniently experiment with a subset of selected cardholders to determine program characteristics that are more highly valued by cardholders.

Through the use of the Cardholder Module, individual cardholders are then able to specifically customize the use of their card to finely tuned environments and circumstances to achieve personal objectives.

For example, a cardholder who is a parent to a college student can customize the rules, conditions and condition values of a credit, debit and/or pre-paid card for use by the student. In particular, the parent can conveniently and in real time input rules, conditions and condition values that would limit the value of individual and aggregated transactions, restrict particular types of from interacting with the cardholder merchants (e.g., such as vendors of alcohol or airline travel), restrict the geographic region in which the card can be utilized (e.g., to the town where a college is located), restrict the time of day in which a card can be utilized (e.g., to between 8 AM and 9 PM). The system also enables the cardholder to monitor conveniently the transactions for which the card is used.

With reference now to FIGS. 65-70, exemplary flowcharts are provided illustrating the operation of one embodiment of an electronic transaction processing system.

FIG. 65A provides the first high level flowchart for one embodiment of configuring rules, conditions, timing parameters, notification requests and condition values for one embodiment of the electronic processing system 100, shown generally at 6500A. In this process, the database is established at step 6510. As has been previously discussed, multiple conceptual databases may be incorporated as tables in a single database, and a single conceptual database may be implemented as multiple databases.

Participants may be granted an interface at step 6520. These interfaces may take many forms, such as a web portal, or dedicated machine, such as a merchant interface device. In addition to providing the participants with an interface, authorization levels may be assigned to selected participants, at step 6530. As has been previously discussed, participants that enjoy a higher level of permission or authorization for adding or modifying rules, conditions, condition values, fees and rewards, may also have a higher level of security associated with their accessing of the decision module 102 and/or other elements of the system.

After participants have been assigned authorization levels, rule and/or condition value updates may be received by one or more of the participants, at step 6535. After receiving the rules, conditions, condition values, fees and/or rewards update, the process may progress to step 6590 where an inquiry is made as to whether the participants have a sufficient authority level. If the participant has the requisite authority level, the process may progress to step 6591, where as discussed above, a first rule checking operation is performed by the decision module 120 to determine whether a proposed change or addition to a rule, condition, condition value, fee and/or reward is consistent with the inputs to such attribute made by other participants of higher authorization levels. If the input is logically inconsistent with a prior input of a higher level participant, e.g., because it attempts to expand upon the scope of transaction previously authorized by a higher level participant, such input is rejected and not entered into the database by the system, and notifications may be generated. If the input is not determined to be logically inconsistent with a prior input of a higher level participant, in step 6592 the input becomes effective with respect to any requested transactions that occur during the period in which it is defined to be in effect, or until modified by an input from another participant of higher or equal level.

In a separate high level process, FIG. 65B illustrates a flowchart for one embodiment of transaction processing for the electronic processing system, shown generally at 6500B. In this process, a transaction request initiated by a participant may be received from an association network (such as VISA, MasterCard or STAR) by the transaction processing system 102, at step 6540. The card and cardholder initiating the requested transaction may then be authenticated, at step 6550, using any of the aforementioned authentication methodologies. After a successful authentication of the card and cardholder, the transaction processing system 102 may accept the requested transaction for processing and parse the received message (e.g., in ISO 8583 standard format) into appropriate data portions in step 6560 that are entered into a data record in the database at step 6562.

A pointer to the parsed data in the data record in the database may then be directed to the decision module 120 at step 6570. The decision module, as previously noted, utilizes the database 104 to store information relevant to each participant authorized and enabled to use the system. Additionally, the decision module 120 may determine if the transaction in progress should be permitted, at step 6580. If the transaction is determined to be permitted, the process then progresses to step 6582 where the transaction is processed. The process then ends.

If at step 6580 the transaction is not determined to be permitted, the process may progress to step 6584 where the transaction is denied.

The process may also permit an inquiry as to whether to continue. If the process continues, the system may idle until another rule access attempt is made by a participant. Then the process progresses back to 6540 where the access attempt is received and the participant is subsequently authorized. Otherwise, if the continuing the process is not desired, the process may end.

FIG. 66 is an exemplary flowchart for establishing and populating databases for the operation of this embodiment of electronic processing system 100, shown generally at 6510. This exemplary process is an expansion of one of the steps from FIG. 65A. When establishing and populating the database, participant records are established at step 6610. An initial set of rules may also be established at step 6620. Timing parameters, notification requests and one or more conditions associated with each rule may be established between steps 6620 and 6630. Condition values may be established at step 6630. Auditable records, e.g., for each requested transaction and for each attempt to modify the database by a participant, are generated and maintained in the database at step 6640. After establishing auditable records, the process may continue by progressing to step 6520 of FIG. 65A.

FIG. 67 is an exemplary flowchart for providing an interface to the participants for the operation of this embodiment of electronic processing system 100, shown generally at 6520. This exemplary process is an expansion of one of the steps from FIG. 65A. This process begins from step 6510 of FIG. 65A and progresses to step 6710, in which participants are enabled to input and/or modify rules, conditions, timing parameters, notification requests, and condition values in the database. As discussed above, participants may be enabled to modify the rules, conditions, timing parameters, notification requests, and condition values in real time, at step 6720.

In some embodiments, conditions and condition values comprises one or more of the following: account balance, account limits, transaction limits, account type, customer identity, geographic location of customer, geographic location of merchant, date, time of day, IP address of participant, category or identity of electronic shopping cart, transaction routing, distribution of funds, and settlement terms.

After enabling modification of the rules, conditions, timing parameters, notification requests, and condition values, the process may continue by progressing to step 6530 of FIG. 65A.

FIG. 68 is an exemplary flowchart for enabling the input of rules, conditions, timing parameters, notification requests, and condition values for the operation of this embodiment electronic processing system 100, shown generally at 6710. This exemplary process is an expansion of one of the steps from FIG. 67. This process begins from step 6510 of FIG. 65A and progresses to step 6810, where fee related rules are established. Fees may be incurred and earned as a result of a requested transaction. These fees may comprise transaction fees, issuance fees, periodic fees, inactivity fees, load fees, interest rates, card replacement fees, fund transfer fees, and revenue sharing.

Additionally, merchant and consumer-reward related rules may be established at step 6820. Such merchant rewards may be earned as a result of a requested transaction. Then, the process may continue by progressing to step 6720 of FIG. 67.

FIG. 69 is an exemplary flowchart for enabling the modification of rules, conditions, timing parameters, notification requests, and condition values for the operation of this embodiment of electronic processing system 100, shown generally at 6720. This exemplary process is an expansion of one of the steps from FIG. 67. This process begins from step 6710 of FIG. 67 and progresses to step 6910, where more than one participant can input conditions and condition values relating to the same rule. In such a circumstance, a hierarchical relationship for conditions and condition values input by different participants relating to the same rule may be established.

Then, at step 6920 business logic may be executed to apply the same rule in a manner consistent with said the established hierarchical relationship. Then, the process may continue by progressing to step 6530 of FIG. 65A.

FIG. 70 is an exemplary flowchart for determining if a requested transaction should be permitted for the operation of this embodiment of electronic processing system 100, shown generally at 6580. This exemplary process is an expansion of one of the steps from FIG. 65B. This process begins from step 6570 of FIG. 65B and progresses to step 7010, where business logic is applied to access rules, conditions, timing parameters, notification requests, and condition values. Then, at step 7020 business logic may be applied to analyze the authorization levels of the participants. Further, at step 7030, business logic may be applied to analyze rules, conditions, timing parameters, notification requests, and condition values for consistency with the authorization level of each participant that contributed to the rules, conditions, timing parameters, notification requests, and condition values. From this analysis, a decision of whether to proceed with the transaction may be reached. This decision may then be output at step 7040. Lastly, the process may continue by progressing to step 6590 of FIG. 65A.

The description of the embodiments set forth herein is illustrative of use of the invention and is not intended to limit the scope thereof, as variations and modifications are possible. Alternatives and equivalents of the various elements of the embodiments may be apparent from this description. These and other variations and modifications of the embodiments disclosed herein may be made without departing from the scope and spirit of the invention as set forth in the claims.

What is claimed is:

1. A computerized electronic transaction processing system for processing a requested transaction that involves a plurality of participants, comprising:
a database management system including a database in which data records can be stored and retrieved;
a transaction module for receiving a request for an electronic transaction in a standardized message format from a banking association network, and wherein said transaction module is configured to interact with a transaction database to verify account information, parse said request into parsed data components, input said parsed data components into a record in said database, and communicate the identity of said database record;
a decision module for receiving from said transaction module the identity of said database record associated with said request, said decision module configured to channel all communication with said banking association network through the transaction module, and wherein said decision module is configured to access said identified database record and to retrieve rules and associated conditions and condition values from said transaction database related to said requested transaction and to apply said rules, conditions and condition values to generate a result that relates to an approval or disapproval decision concerning said requested transaction; and wherein said decision module is further configured to determine one or more response codes applicable to said approval or disapproval decision concerning said requested transaction;
a first interface mechanism associated with said decision module for communicating said one or more response codes applicable to said approval or disapproval decision to said transaction module; and
at least one additional interface mechanism associated with said decision module for communicating with at least one of said plurality of participants to enable said at least one participant to said input rules, conditions and condition values into said transaction database for use by said decision module.

2. The electronic transaction processing system of claim 1, wherein
said a requested transaction can have one or more rules applicable to said approval or disapproval decision;
said rules are adapted to be able to have one or more conditions associated with each rule; and
said conditions are adapted to be able to have one or more condition values associated with each condition.

3. The electronic transaction processing system of claim 2, wherein more than one participant can input conditions or condition values relating to the same rule, and wherein a hierarchical relationship is defined with respect to at least some of said plurality of participants for at least some of said conditions and rules to establish levels of authority among said plurality of a participants for inputting or modifying said condition values, conditions and rules;
wherein an electronic security mechanism is associated with said at least one additional interface mechanism for authenticating a participant attempting to access said at least one transaction database; and
wherein said decision module further comprises:
business logic for accessing said transaction database in response to a requested transaction to retrieve information defining the hierarchical relationship between each participant that inputted or modified any of said identified and retrieved conditions, condition values and rules related to said requested transaction; and
business logic for electronically applying said retrieved rules to said retrieved condition values in accordance with said hierarchical relationship between participants to determine whether to approve or disapprove said requested transaction.

4. The electronic transaction processing system of claim 3, further comprising:
business logic for accessing said transaction database in response to a participant attempting to input or modify a rule, condition or condition value in said transaction database, to retrieve information defining the hierarchical relationship between each participant that inputted or modified said rules, conditions and condition values; and
business logic for validating the propriety of a rule, condition or condition value being input or modified by a participant in accordance with said hierarchical relationship between participants.

5. The electronic transaction processing system of claim 3, wherein said at least one additional interface mechanism is able to input or modify rules, conditions and condition values in real time, whereby said business logic for electronically applying retrieved conditions, condition values and rules is able to apply a newly inputted or modified rule, condition or condition value to a requested transaction promptly after it is introduced into said transaction database.

6. The electronic transaction processing system of claim 1, wherein said conditions comprise one or more of the following:
account balance, account limits, transaction limits, account type, customer identity, geographic location of customer, geographic location of merchant, date, time of day, IP address of participant, category or identity of electronic shopping cart, transaction routing, distribution of funds, and settlement terms.

7. The electronic transaction processing system of claim 1, further comprising:
a set of rules established in said transaction database by one or more of said participants relating to fees to be incurred and earned as a result of a requested transaction.

8. The electronic transaction processing system of claim 6, wherein said fees comprise one or more of the following:
transaction fees, issuance fees, periodic fees, inactivity fees, load fees, interest rates, card replacement fees, fund transfer fees, and revenue sharing.

9. The electronic transaction processing system of claim 1, further comprising:
a set of rules established in said transaction database by one or more of said participants relating to customer or merchant rewards to be earned as a result of a requested transaction.

10. The electronic transaction processing system of claim 1, wherein said transaction database maintains auditable records of each requested transaction and the results of applying said business logic to said retrieved rules, conditions and condition values.

11. A method of operating an electronic transaction processing system involving a plurality of participants, comprising:
establishing at least one database for storing electronic data relating to said participants and condition values and rules relating to electronic transactions;
providing an interface mechanism for at least a plurality of said participants that enables each of said plurality of participants to electronically interact with said at least one database to input or modify condition values and rules in said database;
assigning an authorization level to selected ones of said participants to define a participant's ability to input or modify condition values and rules in said at least one database;
authenticating a participant attempting to access said at least one database to determine said participant's authorization level;
receiving an electronic message including information relating to a requested transaction;
directing said electronic message to a decision module for deciding whether a requested transaction should be permitted to proceed to completion;
applying business logic in said decision module to access condition values and rules from said at least one database;
applying business logic in said decision module to electronically analyze authorization levels of participants to said requested transaction; and
applying business logic in said decision module to electronically analyze condition values and rules from said first set of rules in response to receipt of said electronic message and consistent with the authorization level of each participant that inputted or modified said condition values and rules, to determine whether said requested transaction should be permitted to proceed to completion.

12. The method as set forth in claim 11 wherein said interface mechanism is able to input or modify condition values and rules in real time, whereby said business logic for electronically applying retrieved condition values and rules is able to apply a newly inputted or modified condition value or rule promptly after it is introduced into said at least one database.

13. The method as set forth in claim 11 wherein said set of condition values comprises one or more of the following:
account balance, account limits, transaction limits, account type, customer identity, geographic location of customer, geographic location of merchant, date, time of day, IP address of participant, category or identity of electronic shopping cart, transaction routing, distribution of funds, and settlement terms.

14. The method as set forth in claim 11 further comprising:
establishing a set of rules in said at least one database by one or more of said participants relating to fees to be incurred and earned as a result of a requested transaction.

15. The method as set forth in claim 14 wherein said fees comprise one or more of the following:
transaction fees, issuance fees, periodic fees, inactivity fees, load fees, interest rates, card replacement, fund transfer fees, and revenue sharing.

16. The method as set forth in claim 11 further comprising:
establishing a set of rules in said at least one database by one or more of said participants relating to customer or merchant rewards to be earned as a result of a requested transaction.

17. The method as set forth in claim 11 wherein more than one participant can input condition values relating to the same rule in said set of rules and wherein said decision module further comprises:
establishing a hierarchical relationship for condition values input by different participants relating to the same rule;
executing business logic to apply said same rule in a manner consistent with said hierarchical relationship.

18. The method as set forth in claim 11 wherein said database maintains auditable records of each requested transaction and the results of applying said business logic to said retrieved condition values and rules.

19. A program storage device readable by a machine, tangibly embodying a program of instructions executable by the machine to perform a method for operating an electronic transaction processing system involving a plurality of participants, the method comprising:
establishing at least one database for storing electronic data relating to said participants and condition values and rules relating to electronic transactions;
providing an interface mechanism for at least a plurality of said participants that enables each of said plurality of participants to electronically interact with said at least one database to input or modify condition values and rules in said database;
assigning an authorization level to selected ones of said participants to define a participant's ability to input or modify condition values and rules in said at least one database;
authenticating a participant attempting to access said at least one database to determine said participant's authorization level;
receiving an electronic message including information relating to a requested transaction;
directing said electronic message to a decision module for deciding whether a requested transaction should be permitted to proceed to completion;
applying business logic in said decision module to access condition values and rules from said at least one database;
applying business logic in said decision module to electronically analyze authorization levels of participants to said requested transaction; and
applying business logic in said decision module to electronically analyze condition values and rules from said first set of rules in response to receipt of said electronic message and consistent with authorization level of each participant that inputted or modified said condition values and rules, to determine whether said requested transaction should be permitted to proceed to completion.

20. The method as set forth in claim 19 wherein said interface mechanism is able to input or modify condition values and rules in real time, whereby said business logic for electronically applying retrieved condition values and rules is able to apply a newly inputted or modified condition value or rule promptly after it is introduced into said at least one database.

21. The method as set forth in claim 19 wherein said set of condition values comprises one or more of the following:
account balance, account limits, transaction limits, account type, customer identity, geographic location of customer, geographic location of merchant, date, time of day, IP address of participant, category or identity of electronic shopping cart, transaction routing, distribution of funds, and settlement terms.

22. The method as set forth in claim 19 further comprising:
establishing a set of rules in said at least one database by one or more of said participants relating to fees to be incurred and earned as a result of a requested transaction.

23. The method as set forth in claim 22 wherein said fees comprise one or more of the following:
transaction fees, issuance fees, periodic fees, inactivity fees, load fees, interest rates, card replacement, fund transfer fees, and revenue sharing.

24. The method as set forth in claim 19 further comprising:
establishing a set of rules in said at least one database by one or more of said participants relating to customer or merchant rewards to be earned as a result of a requested transaction.

25. The method as set forth in claim 19 wherein more than one participant can input condition values relating to the same rule in said set of rules and wherein said decision module further comprises:
establishing a hierarchical relationship for condition values input by different participants relating to the same rule;
executing business logic to apply said same rule in a manner consistent with said hierarchical relationship.

26. The method as set forth in claim 19 wherein said database maintains auditable records of each requested transaction and the results of applying said business logic to said retrieved condition values and rules.
